(19) United States
(12) Patent Application Publication
(10) Pub. No.: US 2010/0128663 A1
(43) Pub. Date: May 27, 2010

(54) SIGNAL TRANSMISSION METHOD, RADIO COMMUNICATION SYSTEM, COMMUNICATION STATION, MOBILE STATION, AND BASE STATION

(75) Inventors: Nahoko Kuroda, Tokyo (JP); Jinsock Lee, Tokyo (JP); Koujirou Hamabe, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION, Minato-ku, Tokyo (JP)

(21) Appl. No.: 12/089,351

(22) PCT Filed: Oct. 6, 2006
(86) PCT No.: PCT/JP2006/320056

§ 371 Date: Jul. 7, 2008

(30) Foreign Application Priority Data
Oct. 7, 2005 (JP) 2005-295219

(51) Int. Cl. H04W 40/00

(52) U.S. Cl. 370/328

(57) ABSTRACT

When an RG received from a base station is UP, a mobile station compares E-TFC currently used by a HARQ process for transmitting a signal to the base station from the mobile station with E-TFC previously used for transmission by the same HARQ process. When they are identical, the accumulation information is incremented by one. When selecting E-TFC used for transmission, the HARQ process of the mobile station tales the accumulation information into consideration. Thus, when the accumulation is incremented, the HARQ process selects E-TFC of a level incremented by one and accordingly, the transfer rate of the mobile station is increased and the user throughput is improved.

### APPLICABLE FIELD IN THE INDUSTRY

The present invention relates to a signal transmission method, a radio communication system, a communication station, a mobile station, and a base station.

### BACKGROUND ART

In an EUDCH (Enhanced Uplink Dedicated Channel), which is of an uplink high-speed packet transmission technique in a WCDMA, it is expected that introducing scheduling being performed by a base station, or an HARQ (Hybrid ARQ), which is of a Stop-and-Wait technique, contributes to an enhancement in a capacity and a coverage all the more than an existing uplink of the WCDMA does.

The mobile station for executing an EUDCH operation transmits a DPCCH (Dedicated Physical Control Channel) and an E-DPDCH (Enhanced-Dedicated Physical Data Channel), and an E-DPCCH (Enhanced-Dedicated Physical Control Channel) in the uplink, and a closed loop transmission power control is taken for the transmission power of the DPCCH in the base station so that the transmission power satisfies a predetermined reception quality.

Further, the transmission power of the E-DPDCH is a power obtained by adding a predetermined power offset to the transmission power of the DPCCH, and the higher a transmission rate of the E-DPDCH, the higher the necessary power offset. In the base station, maintaining normal communication necessitates a control of all reception power so that an all reception power-to-heat noise ratio (a noise rise) becomes equal to or less than a predetermined limit value. Thereupon, the base station performs scheduling for the mobile station so that all reception power becomes equal to or less than a predetermined threshold, and controls the power offset (SG: Serving Grant) that the mobile station may use.

On the other hand, the mobile station selects a transmission format of a transport block, which is transmitted at a transmission time interval (TTI) in a physical layer, TTI by TTI. The transmission format of the transport block is called an E-TFC (Enhanced-Transport Format Combination). FIG. 1 is a view illustrating an E-TFC table. As shown in FIG. 1, the E-TFC table is comprised of E-TFC indexes 101, 103, and 105, and transport block sizes (TBS) 102, 104, and 106. Herein, the so-called transport block is a unit by which a coding process is performed in a physical layer, and one transport block includes one PDU (Protocol Data Unit) or plural ones and a header. The so-called PDU is a block of data that is sent from an upper layer (an RLC layer). The base station and the mobile station already know this table. Further, the power offset necessary for transmitting each E-TFC is separately notified from a base station controller before starting transmission of data employing the EUDCU.

The mobile station selects and transmits an appropriate E-TFC according to a predetermined condition from among this E-TFC table. As a rule, the larger the block side being transmitted at a transmission time interval is, the larger the power offset as well required for transmission it becomes proportionally.

FIG. 2 is a block diagram illustrating one example of the transport block, and in this example, a transport block 201 includes three PDCs, i.e. a PDU 202, a PDU 203, and a PDU 204, and a header 205. The PDU can be set to a different block size data flow by data flow, and for example, FIG. 2 indicates the case that the size of the PDU is 320 bits. In this case, one 16-bit header and three PDUs are accommodated in the transport block, so the bit number of the entirety is 976 bits. Thus, the mobile station has to select an E-TFC 13 of which the bit number is 976 bits or more and yet minimum in order to transmit this transport block.

FIG. 14 indicates a relation of the number of the PDU, the E-TFC and the desired power offset. With an increase in the number of the PDU, the E-TFC having a larger transport block size is necessitated, and resultantly, the power offset necessary for transmission augments in proportional to the block size.

FIG. 3 shows an SG updating unit 301 and an E-TFC selecting unit 302 within the mobile station, and a flow of information between these units. The mobile station updates the SG in the SG updating unit 301 based upon a notification from the base station, selects the E-TFC in the E-TFC selecting unit 302 based upon the updated SG, and makes the transmission of the next TTI by employing the selected E-TFC. Further, information of the power offset used for the actual transmission (LUPR: Last Used Power Ratio) is fed back to the SG updating unit. A more detailed operation in the SG updating unit 301 and the E-TFC selecting unit 302 is described below.

### [An Update of the SG]

FIG. 4 is a view illustrating a power offset table. The update of the SG is executed based upon the power offset table shown in FIG. 4. The power offset table, as shown in FIG. 4, is configured of an SG index 401 and a value 402 of the SG. The power offset table is a table indicating a choice of the power offset that can be set by the mobile station, and a set of the SG index and the value of the SG is specified for each approx. one dB, being a difference between the neighboring values of the SGs. Additionally, the value of the SG may be notated by the truth value in some cases, and may be notated by the db value in some cases.

The base station, which uses two roughly-classified kinds of control signals, controls the power offset that the mobile station is permitted to use, i.e. the SG. One control signal, which is called an AG (Absolute Grant), is for notifying (transmitting) the value of the SG index within the power offset table, and the other one, which is called an RG (Relative Grant), is for making a notification (making transmission) so that the value of the SG index within the power offset table is incremented by one (UP), is decremented by one (DOWN), or is maintained as it stands (HOLD). It can be said safely that the AG is a signal for controlling the power offset with an absolute value, and the RG is a signal for relatively controlling the power offset.

FIG. 6 is a view illustrating a system configuration of a radio communication system. The radio communication system is configured of plural base stations and plural mobile stations, and in FIG. 6, base stations 601 and 602, and a plurality of mobile stations 611 to 613 exist, and in addition hereto, a base station controller 620 exits. The mobile station 611, which makes data transmission in the uplink by employing the EUDCH, transmits the DPCCH, E-DPCCH as well as the E-DPDCH. Further, the base station transmits a BCH, the DPCCH, the DPDCH, an E-HICH, and an E-RGCH, as well as an E-AGCH to the mobile station 611. Herein, in each channel, the following signals are transmitted.

BCH: notification information and system information

DPCCH: a pilot signal and a TPC (transmission Power Control) command of the transmission power

DPDCH: downlink data/a downlink control signal

E-DPCCH: a control signal necessary for receiving the E-DPDCH

E-DPDCH: data of high-speed packet transmission

E-HICH: an ACK/NACK signal

E-RGCH: an RG signal

E-AGCH: an AG signal

Further, the mobile station 612, which makes uplink data transmission by using the EUDCH similarly, perform a soft handover in order to be positioned at a cell boundary between the base stations 601 and 602, and both of the base stations receive the DPCCH, the E-DPCCH as well as the E-DPDCH of the mobile station 612. At this time, the number of the base station (Serving BS) performing the scheduling for the E-DPDCH, out of the base stations that are performing the soft handover, is only one. A base station controller to connected to the base station decides the setting of such a soft-handover base station and the Serving BS based upon a notification associated with the reception power of the pilot signal from the mobile station that is common to the downlink of each base station, or the like. It is assumed that a decision result is notified to the mobile station by employing the base station the downlink DPDCH.

Herein, the mobile station executes the reception process at a timing synchronized with a transmission timing of each base station by employing a scrambling code inherent to each base station, thereby making it possible to distinguish each of signals from respective base station from the other. Further, It is assumed that information of the scrambling code inherent to each base station is transmitted with the BCH.

The Serving BS employs the AG as well as the RG to control the SG of the mobile station. The mobile station, as described later, selects the E-TFC based upon the SG etc., and makes the power offset of each TTI, thereby to control the transmission rate of each TTI. With the RG, the increase (UP) and the decrease (DOWN) signify that the transmission is possible, the case (DTX) that no transmission is made signifies the maintenance (HOLD).

The base station other than the Serving BS, out of the base stations that are performing the soft handover, that is, a Non-serving BS transmits the decrease (DOWN) of the RG as a control of the power offset of the mobile station only in a case where the status of the reception power comes into an overload status of exceeding a predetermined condition. Such an RG DOWN, which the Non-serving BS transmits, is specially called an OLI (Over Load Indicator). The case that the Non-serving BS transmits nothing signifies the maintenance (HOLD) similarly to the case of the Serving BS.

At this time, as shown in FIG. 5, a notification of an increase or an decrease in the SG index value, or a maintenance by the RG is made with the power offset (LUPR: Last Use Power Ratio) as a criteria, which has actually been transmitted ahead of a predetermined time in each HARQ process, or, in general, at a transmitting timing ahead of a one-step transmitting time in each HARQ process.

Herein, it is assumed that there exist four HARQ processes, and the mobile station can transmit at most four data blocks without waiting for reception of the ACK signal. Upon receipt of the RG, the mobile station assumes the index of the SG of the minimum power offset, out of the power offsets equal to more than the LUPR in the power offset table, to be SGI_LUPR, and assumes the index of a new SG to be a value obtained by incrementing or decrementing the SGI_LUPR by one. Thus, for example, in a case of having transmitted the E-DPDCH with a power offset SG[act1] lower than SG[sg1], being a Serving Grant in HARQ0(i-1), and having received DOWN of the RG for the transmission made in HARQ0(i), the mobile station decrements not the SG[sg1] but the SG[act1] by one step. The situation in which the actual transmission power becomes lower than the SG in such a manner occurs, for example, due to selection of the minimum transmission rate that is enough for transmitting the data quantity within a buffer if the data quantity within the buffer is smaller than the data quantity that can be transmitted with SG[sg1]. Employing the SGI_LUPR as a criteria of the RG in such a manner gives rise to the advantage that, if the base station desires to decrease the reception power, the SG can be decreased more quickly as compared with the case of decreasing the SG by decrementing the SG[sg1]. Additionally, SG[j] is a denotation indicating the value of the SG of which the SG index is j.

Additionally, in some cases, it is assumed that the transmission ahead of a predetermined time in each HARQ process, or, in general, the transmission at a transmitting timing ahead of a one-step transmitting time in each HARQ process is denoted as a last-time transmission in an identical HARQ process hereinafter.

The SG updated according to the rule mentioned above is used for selecting the E-TFC.

[Selection of the E-TFC]

The E-TFC selecting unit selects one E-TFC that conforms to the following condition based upon the updated SGs.

(1) The E-TFC of which the power offset is equal to or less than the SG

(2) The E-TFC that can be transmitted with the power that can be used for the E-DPDCH of the current mobile station.

(3) The minimum E-TFC with which the data within the buffer can be transmitted as much as possible.

The E-TFC selecting unit generates the transport block according to the selected E-TFC, and transmits the E-DPDCH with power obtained by adding the power offset of its E-TFC to the transmission power of the DPCCH.

For example, when the SG is (19/15)², the E-TFC of which the E-TFC index is 5 is selected in the above-mentioned (1). And, the selection is made in such a manner that the E-TFC of which the E-TFC index is 4 is furthermore selected in (2) because the power that can be used for the E-DPDCH of the mobile station is limited, and the E-TFC of which the E-TFC index is 2 is furthermore selected in (3) because only data of two PDUs exists in the buffer.

The operation above is described in details in Non-patent document 1 and Non-patent document 2.

Non-patent document 1: 3rd Generation Partnership Project; Technical Specification Group Radio Access Network; Medium Access Control (MAC) protocol specification (Release 6), 3GPP TS25.321 v6.5.0, June 2005. Non-patent document 2: 3rd Generation Partnership Project; Technical Specification Group Radio Access Network; FDD Enhanced Uplink; Overall description; Stage 2 (Release 6), 3GPP TS25.309 v6.3.0, June 2005.

### DISCLOSURE OF THE INVENTION

### Problems to be Solved by the Invention

However, the SG update in the EUDCH explained above has the following problems.

Hereinafter, it is assumed that the E-TFC index value being i is denoted as E-TFC i.

In addition hereto, it is assumed that the SG index value being j is denoted as SG index j.

As shown in FIG. 1, an increase rate of the transport block size accompanied by an increase by one in the number of the PDU is large in a region in which the E-TFC is small. For example, the transport block size of an E-TFC 7 (the number of the PDU in the transport block is two) becomes almost two times as large as that of an E-TFC 4 (the number of the PDU in the transport block is one), whereby the required power offset as well increases by 3 dB or so. This means that the value of the SG index has to be increased from 3 to 6. Additionally, as described above, when the RG is used, the power offset is increased one step by one step. Thus, an attempt for causing the mobile station, which is now making transmission with the E-TFC 4, to increase the SG so that the E-TFC 7 can be transmitted, incurs the problem described below.

For example, it is assumed that the mobile station has transmitted data at a time T0 with the E-TFC 4 listed in FIG. 1, and thereafter, has received UP of the RG. At this time, the power offset used at the time T0 for transmission is an SG index 3, whereby with the SG index 4 obtained by incrementing this by one assumed to be a new SG, the mobile station selects the E-TFC that is transmitted at a next transmitting timing T1. However, upon making a reference to the offset table of FIG. 4, with the SG index 4, the SG is (9/15)², which does not reach (12/15)², being a power offset of the E-TFC 7 (SG index 6) that can be transmitted with the block size in which the number of the PDU has been incremented by one in FIG. 14. For this reason, the mobile station results in transmitting the E-TFC 4 with the power offset of the SG index 3, being the power offset of the E-TFC 4, at a time T1 as well similarly to the time T0.

The base station transmits UP of the RG again to the mobile station because the E-TFC at the time T1 has not been increased. However, the mobile station selects the E-TFC at the next transmitting timing T2 as well with SG index 4 obtained by incrementing the SG index 3 by one assumed to be a new SG index similarly to the case of selecting the E-TFC at the time T1 because the update of the SG is made with the power offset actually used at the time T1, i.e. the SG index 3 assumed to a criteria. Thus, it follows that only the E-TFC 4 can be selected at a time T2 as well.

In such a manner, the mobile station comes into a situation where the E-TFC larger than the current one cannot be selected even though the base station repeats a notification saying RG UP many times. Thus, the current EUDCH has the problem that, once the E-TFC of which the number of the PDC is small is selected, even though the base station gives an instruction for UP by the RG, selection of the E-TFC of which the E-TFC index is larger than that of the current E-TFC is made impossible, the transmission rate of the mobile station cannot be increased, and a user throughput remarkably declines.

Further, in such a case, employing the AG previously explained enables the E-TFC to be directly increased with the desired SG; however, the information quantity of the AG is enormously much as compared with that of the RG because with AG, the SG index itself is notified. That is, so as to transmit the AG, an overhead larger than that of the RG is necessitated, and resultantly, a throughput of the entirety of the system decline, which arouses the problem.

The present invention has an object of solving the points at issue mentioned above.

### Means for Solving the Problems

The first invention for solving the above-mentioned problems, which is a signal transmission method in a radio communication system being configured at least of a base station and a mobile station, is characterized in that the base station includes a step of transmitting a signal for notifying a request for changing a radio resource quantity that the mobile station may use, and the mobile station includes a step of receiving the signal, and a step of updating the radio resource quantity that the mobile station may use responding to the signal, accumulation information of the signal, and the radio resource quantity used ahead of a predetermined time.

The second invention for solving the above-mentioned problems is characterized in that, in the foregoing invention, the mobile station further includes a step of transmitting a signal with the radio resource quantity equal to or less than the updated radio resource quantity.

The third invention for solving the above-mentioned problems is characterized in that, in one of the foregoing inventions, the mobile station further includes a step of increasing the accumulation information when a transmission format of the signal from the mobile station to the base station selected by the mobile station based upon a result of receiving a signal for giving an instruction for increasing the radio resource quantity is identical to a transmission format of the signal used ahead of a predetermined time.

The fourth invention for solving the above-mentioned problems is characterized in that, in one of the foregoing inventions, the mobile station further includes a step of increasing the accumulation information when the radio resource quantity updated based upon reception of a signal for giving an instruction for increasing the radio resource quantity is identical to the radio resource quantity that existed ahead of a predetermined time.

The fifth invention for solving the above-mentioned problems is characterized in that, in one of the foregoing inventions, the mobile station further includes a step of increasing the accumulation information when the radio resource quantity updated based upon reception of a signal for giving an instruction for increasing the radio resource quantity is identical to a value based upon the radio resource quantity that existed ahead of a predetermined time and the accumulation information.

The sixth invention for solving the above-mentioned problems is characterized in that, in one of the foregoing inventions, the mobile station further includes a step of increasing the accumulation information when the radio resource quantity updated based upon reception of a signal for giving an instruction for increasing the radio resource quantity is identical to a value obtained by subtracting the accumulation information from the radio resource quantity.

The seventh invention for solving the above-mentioned problems is characterized in that, in one of the foregoing inventions, the mobile station further includes a step of receiving a signal for giving an instruction for increasing the radio resource quantity, and increasing the accumulation information when the transmission format selected based upon the signal is identical to a transmission format used ahead of a predetermined time.

The eighth invention for solving the above-mentioned problems is characterized in that, in one of the foregoing inventions, the mobile station resets the accumulation information to a predetermined initial value at the time of having received a signal for giving an instruction for decreasing the radio resource quantity.

The ninth invention for solving the above-mentioned problems is characterized in that, in one of the foregoing inventions, the mobile station resets the accumulation information to a predetermined initial value in a case of having selected a transmission format different from the transmission format used ahead of the predetermined time.

The tenth invention for solving the above-mentioned problems is characterized in that, in one of the foregoing inventions, the mobile station resets the accumulation information to a predetermined initial value when the radio resource quantity that the mobile station may use differs from the radio resource quantity used ahead of the predetermined time.

The eleventh invention for solving the above-mentioned problems is characterized in that, in one of the foregoing inventions, the mobile station resets the accumulation information to a predetermined initial value when the radio resource quantity updated based upon reception of a signal for giving an instruction for increasing the radio resource quantity differs from a value obtained by subtracting the accumulation information from the radio resource quantity.

The twelfth invention for solving the above-mentioned problems is characterized in that, in one of the foregoing inventions, the mobile station includes a step of receiving from the base station information corresponding to an absolute value of the radio resource quantity that the mobile station may use, and resets the accumulation information to a predetermined initial value upon receipt of the information corresponding to the absolute value.

The thirteenth invention for solving the above-mentioned problems is characterized in, in one of the foregoing inventions, assuming the predetermined initial value to be 0 (zero).

The fourteenth invention for solving the above-mentioned problems is characterized in that, in one of the foregoing inventions, the mobile station decreases the accumulation information at the time of having received a signal for giving an instruction for decreasing the radio resource quantity.

The fifteenth invention for solving the above-mentioned problems is characterized in that, in one of the foregoing inventions, the mobile station, upon receipt of a signal for notifying a request for changing the radio resource quantity that the above mobile station may use from a first base station, updates the accumulation information based upon its result, and does not change the accumulation information notwithstanding reception of a signal from a second base station, which is for notifying a decrease in the radio resource quantity that the above mobile station may use.

The sixteenth invention for solving the above-mentioned problems, which is a signal transmission method in a radio communication system being configured at least of a base station and a mobile station, characterized in that the base station includes a step of transmitting a signal for notifying a request for changing a radio resource quantity that the mobile station may use, and the mobile station includes: a step of receiving the signal; a step of, when the signal is a signal from the base station performing scheduling for the radio resource quantity of the mobile station, which is for notifying a request for changing the radio resource quantity that the above mobile station may use, updating the accumulation information based upon its result; and a step of updating the radio resource quantity that the mobile station may use responding to the signal, accumulation information of the signal, and the radio resource quantity used ahead of a predetermined time.

The seventeenth invention for solving the above-mentioned problems is characterized in, in one of the foregoing inventions, not changing the accumulation information in a case where a transmission format used ahead of the predetermined time does not belong to a subset of a predetermined transmission format.

The eighteenth invention for solving the above-mentioned problems is characterized in that, in one of the foregoing inventions, only in a case where a transmission format used ahead of the predetermined time belongs to a subset of a predetermined transmission format, the mobile station increases the accumulation information based upon reception of a signal for giving an instruction for increasing the radio resource quantity.

The nineteenth invention for solving the above-mentioned problems is characterized in that, in one of the foregoing inventions, in a case where a transmission format used ahead of the predetermined time does not belong to a subset of a predetermined transmission format, the mobile station assumes the accumulation information to be 0 (zero) at the time of having received a signal for giving an instruction for decreasing the radio resource quantity.

The twentieth invention for solving the above-mentioned problems is characterized in that, in one of the foregoing inventions, the transmission format is an E-TFC.

The twenty-first invention for solving the above-mentioned problems is characterized in that, in one of the foregoing inventions, the so-called radio resource quantity is a value associated with a transmission power of a radio communication channel.

The twenty-second invention for solving the above-mentioned problems is characterized in that, in one of the foregoing inventions, the so-called radio resource quantity is a power offset of an uplink channel from the mobile station to the base station.

The twenty-third invention for solving the above-mentioned problems is characterized in that, in one of the foregoing inventions, the mobile station assumes that the power offset of the uplink channel is a power offset for the transmission power of the individual channel controlled by a closed loop transmission power control so that it has a predetermined reception quality.

The twenty-fourth invention for solving the above-mentioned problems is characterized in, in one of the foregoing inventions, not increasing the accumulation information in a case where the accumulation information has reached a predetermined maximum value.

The twenty-fifth invention for solving the above-mentioned problems, which is a signal transmission method in a radio communication system being configured at least of a base station and a mobile station, characterized in that the base station includes a step of transmitting a signal for relatively controlling a permitted radio resource quantity of the mobile station, and the mobile station includes a step of receiving the signal, and a step of updating the permitted radio resource quantity responding to the control signal, a result of requesting a change to the permitted radio resource quantity, and magnitude of the radio resource quantity used ahead of a predetermined time.

The twenty-sixth invention for solving the above-mentioned problems is characterized in that, in one of the foregoing inventions, the mobile station further includes a step of transmitting a signal with the radio resource quantity equal to or less than the permitted radio resource quantity that has been updated.

The twenty-seventh invention for solving the above-mentioned problems is characterized in that, in one of the foregoing inventions, the so-called radio resource quantity is a value associated with a transmission power of a radio communication channel.

The twenty-eighth invention for solving the above-mentioned problems is characterized in that, in one of the foregoing inventions, the so-called radio resource quantity is a power offset of an uplink channel from the mobile station to the base station.

The twenty-ninth invention for solving the above-mentioned problems is characterized in that, in one of the foregoing inventions, the mobile station assumes that the power offset of the uplink channel is a power offset for the transmission power of the individual channel controlled by a closed loop transmission power control so that it has a predetermined reception quality.

The thirtieth invention for solving the above-mentioned problems is characterized in that a first communication station includes a step of transmitting a signal for relatively controlling a permitted radio resource quantity of a second communication station, and the second communication station includes a step of receiving the control signal, and a step of updating the permitted radio resource quantity responding to the control signal, a result of requesting a change to the permitted radio resource quantity, and magnitude of the radio resource quantity used ahead of a predetermined time.

The thirty-first invention for solving the above-mentioned problems is characterized in that, in one of the foregoing inventions, the second communication station further includes a step of transmitting a signal with the radio resource quantity equal to or less than the permitted radio resource quantity that has been updated.

The thirty-second invention for solving the above-mentioned problems, which is a radio communication system being configured at least of a base station and a mobile station, characterized in that the base station includes a means for transmitting a signal for notifying a request for changing a radio resource quantity that the mobile station may use, and the mobile station includes a means for receiving the signal, and an updating means for updating the radio resource quantity that the mobile station may use responding to the signal, accumulation information of the signal, and the radio resource quantity used ahead of a predetermined time.

The thirty-third invention for solving the above-mentioned problems is characterized in that, in one of the foregoing inventions, the mobile station further includes an accumulation information measuring means for increasing the accumulation information when a transmission format of the signal from the mobile station to the base station selected by the mobile station based upon a result of receiving a signal for giving an instruction for increasing the radio resource quantity is identical to a transmission format of the signal used ahead of a predetermined time.

The thirty-fourth invention for solving the above-mentioned problems is characterized in that, in one of the foregoing inventions, the mobile station further includes an accumulation information measuring means for increasing the accumulation information when the radio resource quantity updated based upon reception of a signal for giving an instruction for increasing the radio resource quantity is identical to the radio resource quantity that existed ahead of a predetermined time.

The thirty-fifth invention for solving the above-mentioned problems is characterized in that, in one of the foregoing inventions, the mobile station further includes an accumulation information measuring means for increasing the accumulation information when the radio resource quantity updated based upon reception of a signal for giving an instruction for increasing the radio resource quantity is identical to a value based upon the radio resource quantity that existed ahead of a predetermined time and the accumulation information.

The thirty-sixth invention for solving the above-mentioned problems is characterized in that, in one of the foregoing inventions, the mobile station further includes an accumulation information measuring means for increasing the accumulation information when the radio resource quantity updated based upon reception of a signal for giving an instruction for increasing the radio resource quantity is identical to a value obtained by subtracting the accumulation information from the radio resource quantity.

The thirty-seventh invention for solving the above-mentioned problems is characterized in that, in one of the foregoing inventions, the mobile station further includes an accumulation information measuring means for receiving a signal for giving an instruction for increasing the radio resource quantity, and increasing the accumulation information when a transmission format selected based upon the signal is identical to a transmission format used ahead of a predetermined time.

The thirty-eighth invention for solving the above-mentioned problems is characterized in that, in one of the foregoing inventions, the mobile station further includes: a transmitting means for transmitting a signal with the radio resource quantity equal to or less than the updated radio resource quantity; a transmission power measuring unit for measuring a power with which the transmitting means has transmitted the signal; and a selecting means for selecting a transmission format of the signal being transmitted from the transmitting means based upon a measurement result by the transmission power measuring unit and the radio resource quantity updated by the updating means that the mobile station may use.

The thirty-ninth invention for solving the above-mentioned problems is characterized in that, in one of the foregoing inventions, the accumulation information measuring means of the mobile station resets the accumulation information to a predetermined initial value at the time of having received a signal for giving an instruction for decreasing the radio resource quantity.

The fortieth invention for solving the above-mentioned problems is characterized in that, in one of the foregoing inventions, the accumulation information measuring means of the mobile station resets the accumulation information to a predetermined initial value in a case where the selecting means has selected a transmission format different from the transmission format used ahead of the predetermined time.

The forty-first invention for solving the above-mentioned problems is characterized in that, in one of the foregoing inventions, the accumulation information measuring means of the mobile station resets the accumulation information to a predetermined initial value when the radio resource quantity that the mobile station may use differs from the radio resource quantity used ahead of the predetermined time.

The forty-second invention for solving the above-mentioned problems is characterized in that, in one of the foregoing inventions, the accumulation information measuring means of the mobile station resets the accumulation information to a predetermined initial value when the radio resource quantity updated based upon reception of a signal for giving an instruction for increasing the radio resource quantity differs from a value obtained by subtracting the accumulation information from the radio resource quantity.

The forty-third invention for solving the above-mentioned problems is characterized in that, in one of the foregoing inventions, the accumulation information measuring means of the mobile station includes a means for receiving from the base station information corresponding to an absolute value of the radio resource quantity that the mobile station may use, and resets the accumulation information to a predetermined initial value upon receipt of the information corresponding to the absolute value.

The forty-fourth invention for solving the above-mentioned problems is characterized in, in one of the foregoing inventions, assuming the predetermined initial value to be 0 (zero).

The forty-fifth invention for solving the above-mentioned problems is characterized in that, in one of the foregoing inventions, the accumulation information measuring means of the mobile station decreases the accumulation information at the time of having received a signal for giving an instruction for decreasing the radio resource quantity.

The forty-sixth invention for solving the above-mentioned problems is characterized in that, in one of the foregoing inventions, the accumulation information measuring means of the mobile station, upon receipt a signal for notifying a request for changing the radio resource quantity that the above mobile station may use from a first base station, updates the accumulation information based upon its result, and does not change the accumulation information notwithstanding reception of a signal from a second base station, which is for notifying a decrease in the radio resource quantity that the above mobile station may use.

The forty-seventh invention for solving the above-mentioned problems, which is a radio communication system being configured at least of a base station and a mobile station, characterized in that the base station includes a means for transmitting a signal for notifying a request for changing a radio resource quantity that the mobile station may use, and the mobile station includes: a means for receiving the signal; a measuring means for, when the signal is a signal from the base station performing scheduling for the radio resource quantity of the mobile station, which is for notifying a request for changing the radio resource quantity that the above mobile station may use, measuring the accumulation information based upon its result; and an updating means for updating the radio resource quantity that the mobile station may use responding to the signal, accumulation information of the signal, and the radio resource quantity used ahead of a predetermined time.

The forty-eighth invention for solving the above-mentioned problems is characterized in, in one of the foregoing inventions, not changing the accumulation information in a case where a transmission format used ahead of the predetermined time does not belong to a subset of a predetermined transmission format.

The forty-ninth invention for solving the above-mentioned problems is characterized in that, in one of the foregoing inventions, only in a case where a transmission format used ahead of the predetermined time belongs to a subset of a predetermined transmission format, the mobile station increases the accumulation information based upon reception of a signal for giving an instruction for increasing the radio resource quantity.

The fiftieth invention for solving the above-mentioned problems is characterized in that, in one of the foregoing inventions, in a case where a transmission format used ahead of the predetermined time does not belong to a subset of a predetermined transmission format, the mobile station assumes the accumulation information to be 0 (zero) at the time of having received a signal for giving an instruction for decreasing the radio resource quantity.

The fifty-first invention for solving the above-mentioned problems is characterized in that, in one of the foregoing inventions, the transmission format is an E-TFC.

The fifty-second invention for solving the above-mentioned problems is characterized in that, in one of the foregoing inventions, the so-called radio resource quantity is a value associated with a transmission power of a radio communication channel.

The fifty-third invention for solving the above-mentioned problems is characterized in that, in one of the foregoing inventions, the so-called radio resource quantity is a power offset of an uplink channel from the mobile station to the base station.

The fifty-fourth invention for solving the above-mentioned problems is characterized in that, in one of the foregoing inventions, the mobile station assumes that the power offset of the uplink channel is a power offset for the transmission power of the individual channel controlled by a closed loop transmission power control so that it has a predetermined reception quality.

The fifty-fifth invention for solving the above-mentioned problems is characterized in, in one of the foregoing inventions, not increasing the accumulation information in a case where the accumulation information has reached a predetermined maximum value.

The fifty-sixth invention for solving the above-mentioned problems, which is a radio communication system being configured at least of a base station and a mobile station, characterized in that the base station includes a means for transmitting a signal for relatively controlling a permitted radio resource quantity of the mobile station, and the mobile station includes a means for receiving the signal, and a means for updating the permitted radio resource quantity responding to the control signal, a result of requesting a change to the permitted radio resource quantity, and magnitude of the radio resource quantity used ahead of a predetermined time.

The fifty-seventh invention for solving the above-mentioned problems is characterized in that, in one of the foregoing inventions, the mobile station further includes a means for transmitting a signal with the radio resource quantity equal to or less than the permitted radio resource quantity has been updated.

The fifty-eighth invention for solving the above-mentioned problems is characterized in that, in one of the foregoing inventions, the so-called radio resource quantity is a value associated with a transmission power of a radio communication channel.

The fifty-ninth invention for solving the above-mentioned problems is characterized in that, in one of the foregoing inventions, the so-called radio resource quantity is a power offset of an uplink channel from the mobile station to the base station.

The sixtieth invention for solving the above-mentioned problems is characterized in that, in one of the foregoing inventions, the mobile station assumes that the power offset of the uplink channel is a power offset for the transmission power of the individual channel controlled by a closed loop transmission power control so that it has a predetermined reception quality.

The sixty-first invention for solving the above-mentioned problems, which is a radio communication system being configured at least of a first communication station and a second communication station, characterized in that the first communication station includes a means for transmitting a signal for relatively controlling a permitted radio resource quantity of the second communication station, and the second communication station includes a means for receiving the control signal, and an updating means for updating the permitted radio resource quantity responding to the control signal, a result of requesting a change to the permitted radio resource quantity, and magnitude of the radio resource quantity used ahead of a predetermined time.

The sixty-second invention for solving the above-mentioned problems is characterized in that, in one of the foregoing inventions, the second communication station further includes a means for transmitting a signal with the radio resource quantity equal to or less than the permitted radio resource quantity that has been updated.

The sixty-third invention for solving the above-mentioned problems, which is a mobile station in a radio communication system, is characterized in including a means for receiving from a base station a signal for notifying a request for changing a radio resource quantity that its own station may use, and an updating means for updating the radio resource quantity that its own station may use responding to the signal, accumulation information of the signal, and the radio resource quantity used ahead of a predetermined time.

The sixty-fourth invention for solving the above-mentioned problems is characterized in, in the foregoing invention, further including an accumulation information measuring means for measuring as the accumulation information the number of times in the case that a transmission format of the signal from its own station to the base station selected based upon a result of receiving a signal for giving an instruction for increasing the radio resource quantity of the its own station is identical to a transmission format of the signal used ahead of a predetermined time.

The sixty-fifth invention for solving the above-mentioned problems is characterized in, in one of the foregoing inventions, further including an accumulation information measuring means for increasing the accumulation information when the radio resource quantity updated based upon reception of the signal for giving an instruction for increasing the radio resource quantity is identical to the radio resource quantity that existed ahead of a predetermined time.

The sixty-sixth invention for solving the above-mentioned problems is characterized in, in one of the foregoing inventions, further including an accumulation information measuring means for increasing the accumulation information when the radio resource quantity updated based upon reception of the signal for giving an instruction for increasing the radio resource quantity is identical to a value based upon the radio resource quantity that existed ahead of a predetermined time and the accumulation information.

The sixty-seventh invention for solving the above-mentioned problems is characterized in, in one of the foregoing inventions, further including an accumulation information measuring means for increasing the accumulation information when the radio resource quantity updated based upon reception of the signal for giving an instruction for increasing the radio resource quantity is identical to a value obtained by subtracting the accumulation information from the radio resource quantity.

The sixty-eighth invention for solving the above-mentioned problems is characterized in, in one of the foregoing inventions, further including an accumulation information measuring means for receiving a signal for giving an instruction for increasing the radio resource quantity, and increasing the accumulation information when the transmission format selected based upon the signal is identical to a transmission format used ahead of a predetermined time.

The sixty-ninth invention for solving the above-mentioned problems is characterized in that, in one of the foregoing inventions, the accumulation information measuring means resets the accumulation information to a predetermined initial value at the time of having received a signal for giving an instruction for decreasing the radio resource quantity.

The seventieth invention for solving the above-mentioned problems is characterized in, in one of the foregoing inventions, further including: a transmitting means for transmitting a signal with the radio resource quantity equal to or less than the updated radio resource quantity; a transmission power measuring unit for measuring a power with which the transmitting means has transmitted the signal; and a selecting means for selecting a transmission format of the signal being transmitted from the transmitting means based upon a measurement result by the transmission power measuring unit and the radio resource quantity updated by the updating means that the mobile station may use.

The seventy-first invention for solving the above-mentioned problems is characterized in that, in one of the foregoing inventions, the accumulation information measuring means resets the accumulation information to a predetermined initial value in a case where the selecting means having selected a transmission format different from the transmission format used ahead of the predetermined time.

The seventy-second invention for solving the above-mentioned problems is characterized in that, in one of the foregoing inventions, the accumulation information measuring means resets the accumulation information to a predetermined initial value when the radio resource quantity that its own station may use differs from the radio resource quantity used ahead of the predetermined time.

The seventy-third invention for solving the above-mentioned problems is characterized in that, in one of the foregoing inventions, the accumulation information measuring means resets the accumulation information to a predetermined initial value when the radio resource quantity updated based upon reception of a signal for giving an instruction for increasing the radio resource quantity differs from a value obtained by subtracting the accumulation information from the radio resource quantity.

The seventy-fourth invention for solving the above-mentioned problems is characterized in that, in one of the foregoing inventions, the accumulation information measuring means includes a means for receiving from the base station information corresponding to an absolute value of the radio resource quantity that its own station may use, and resets the accumulation information to a predetermined initial value upon receipt of the information corresponding to the absolute value.

The seventy-fifth invention for solving the above-mentioned problems is characterized in, in one of the foregoing inventions, assuming the predetermined initial value to be 0 (zero).

The seventy-sixth invention for solving the above-mentioned problems is characterized in that, in one of the foregoing inventions, the accumulation information measuring means decreases the accumulation information at the time of having received a signal for giving an instruction for decreasing the radio resource quantity.

The seventy-seventh invention for solving the above-mentioned problems is characterized in that, in one of the foregoing inventions, the accumulation information measuring means, upon receipt of a signal for notifying a request for changing the radio resource quantity that its own station may use from the first base station, updates the accumulation information based upon its result, and does not change the accumulation information notwithstanding reception of a signal from the second base station, which is for notifying a decrease in the radio resource quantity that its own station may use.

The seventy-eighth invention for solving the above-mentioned problems, in one of the foregoing inventions, which is a mobile station in a radio communication system, is characterized in including: a means for receiving from a base station a signal for notifying a request for changing a radio resource quantity that its own station may use; a measuring means for, when the signal is a signal from the base station performing scheduling for the radio resource quantity of its own station, which is for notifying a request for changing the radio resource quantity that its own station may use, measuring the accumulation information based upon its result; and an updating means for updating the radio resource quantity that its own station may use responding to the signal, accumulation information of the signal, and the radio resource quantity used ahead of a predetermined time.

The seventy-ninth invention for solving the above-mentioned problems is characterized in, in one of the foregoing inventions, not changing the accumulation information in a case where a transmission format used ahead of the predetermined time does not belong to a subset of a predetermined transmission format.

The eightieth invention for solving the above-mentioned problems is characterized in that, in one of the foregoing inventions, only in a case where a transmission format used ahead of the predetermined time belongs to a subset of a predetermined transmission format, the mobile station increases the accumulation information based upon reception of a signal for giving an instruction for increasing the radio resource quantity.

The eighty-first invention for solving the above-mentioned problems is characterized in that, in one of the foregoing inventions, in a case where a transmission format used ahead of the predetermined time does not belong to a subset of a predetermined transmission format, the mobile station assumes the accumulation information to be 0 (zero) at the time of having received a signal for giving an instruction for decreasing the radio resource quantity.

The eighty-second invention for solving the above-mentioned problems is characterized in that, in one of the foregoing inventions, the transmission format is an E-TFC.

The eighty-third invention for solving the above-mentioned problems is characterized in that, in one of the foregoing inventions, the so-called radio resource quantity is a value associated with a transmission power of a radio communication channel.

The eighty-fourth invention for solving the above-mentioned problems is characterized in that, in one of the foregoing inventions, the so-called radio resource quantity is a power offset of an uplink channel from its own station to the base station.

The eighty-fifth invention for solving the above-mentioned problems is characterized in, in one of the foregoing inventions, assuming that the power offset of the channel from its own station to the base station is a power offset for the transmission power of the individual channel controlled by a closed loop transmission power control so that it has a predetermined reception quality.

The eighty-sixth invention for solving the above-mentioned problems is characterized in, in one of the foregoing inventions, not increasing the accumulation information in a case where the accumulation information has reached a predetermined maximum value.

The eighty-seventh invention for solving the above-mentioned problems, which is a mobile station in a radio communication system, is characterized in including a means for receiving from a base station s signal for relatively controlling a permitted radio resource quantity of its own station and a means for updating the permitted radio resource quantity responding to the control signal, a result of requesting a change to the permitted radio resource quantity, and magnitude of the radio resource quantity used ahead of a predetermined time.

The eighty-eighth invention for solving the above-mentioned problems is characterized in, in one of the foregoing inventions, further including a means for transmitting a signal with the radio resource quantity equal to or less than the permitted radio resource quantity that has been updated.

The eighty-ninth invention for solving the above-mentioned problems is characterized in that, in one of the foregoing inventions, the so-called radio resource quantity is a value associated with a transmission power of a radio communication channel.

The ninetieth invention for solving the above-mentioned problems is characterized in, in one of the foregoing inventions, the so-called radio resource quantity is a power offset of an uplink channel from its own station to the base station.

The ninety-first invention for solving the above-mentioned problems is characterized in, in one of the foregoing inventions, assuming that the power offset of the channel from its own station to the base station is a power offset for the transmission power of the individual channel controlled by a closed loop transmission power control so that it has a predetermined reception quality.

The ninety-second invention for solving the above-mentioned problems, which is a mobile station in a radio communication system, is characterized in including a means for receiving a signal for relatively controlling a permitted radio resource quantity of its own station from a base station, and an updating means for updating the permitted radio resource quantity responding to the control signal, a result of requesting a change to the permitted radio resource quantity, and magnitude of the radio resource quantity used ahead of a predetermined time.

The ninety-third invention for solving the above-mentioned problems is characterized in, in one of the foregoing inventions, further including a means for transmitting a signal with the radio resource quantity equal to or less than the permitted radio resource quantity that has been updated.

The ninety-fourth invention for solving the above-mentioned problems, which is a base station, is characterized in transmitting to the mobile station a signal for notifying a request for changing the radio resource quantity that the above mobile station may use.

The ninety-fifth invention for solving the above-mentioned problems, which is a signal transmission method in a mobile station of a radio communication system, is characterized in including a steps of receiving from a base station a signal for notifying a request for changing a radio resource quantity that its own station may use, and a step of updating the radio resource quantity that the mobile station may use responding to the signal, accumulation information of the signal, and the radio resource quantity used ahead of a predetermined time.

The ninety-sixth invention for solving the above-mentioned problems is characterized in, in one of the foregoing inventions, further including a step of transmitting a signal with the radio resource quantity equal to or less than the updated radio resource quantity.

The ninety-seventh invention for solving the above-mentioned problems is characterized in, in one of the foregoing inventions, further including a step of increasing the accumulation information when a transmission format of the signal from the communication station to the base station selected based upon a result of receiving a signal for giving an instruction for increasing the radio resource quantity is identical to a transmission format of the signal used ahead of a predetermined time.

The ninety-eighth invention for solving the above-mentioned problems is characterized in, in one of the foregoing inventions, further including a step of increasing the accumulation information when the radio resource quantity updated based upon a result of receiving a signal for giving an instruction for increasing the radio resource quantity is identical to the radio resource quantity that existed ahead of a predetermined time.

The ninety-ninth invention for solving the above-mentioned problems is characterized in, in one of the foregoing inventions, further including a step of increasing the accumulation information when the radio resource quantity updated based upon reception of a signal for giving an instruction for increasing the radio resource quantity is identical to a value based upon the radio resource quantity that existed ahead of a predetermined time and the accumulation information.

The hundredth invention for solving the above-mentioned problems is characterized in, in one of the foregoing inventions, further including a step of increasing the accumulation information when the radio resource quantity updated based upon reception of a signal for giving an instruction for increasing the radio resource quantity is identical to a value obtained by subtracting the accumulation information from the radio resource quantity.

The hundred-first invention for solving the above-mentioned problems is characterized in, in one of the foregoing inventions, further including a step of receiving a signal for giving an instruction for increasing the radio resource quantity, and increasing the accumulation information when a transmission format selected based upon the signal is identical to a transmission format used ahead of a predetermined time.

The hundred-second invention for solving the above-mentioned problems is characterized in, in one of the foregoing inventions, resetting the accumulation information to be a predetermined initial value at the time of having received a signal for giving an instruction for decreasing the radio resource quantity.

The hundred-third invention for solving the above-mentioned problems is characterized in, in one of the foregoing inventions, resetting the accumulation information to be a predetermined initial value in a case of having selected a transmission format different from the transmission format used ahead of the predetermined time.

The hundred-fourth invention for solving the above-mentioned problems is characterized in, in one of the foregoing inventions, resetting the accumulation information to a predetermined initial value when the radio resource quantity that its own station may use differs from the radio resource quantity used ahead of the predetermined time.

The hundred-fifth invention for solving the above-mentioned problems is characterized in, in one of the foregoing inventions, resetting the accumulation information to a predetermined initial value when the radio resource quantity updated based upon reception of a signal for giving an instruction for increasing the radio resource quantity differs from a value obtained by subtracting the accumulation information from the radio resource quantity.

The hundred-sixth invention for solving the above-mentioned problems is characterized in, in one of the foregoing inventions, including a step of receiving from the base station information corresponding to an absolute value of the radio resource quantity that its own station may use, and resetting the accumulation information to a predetermined initial value upon receipt of the information corresponding to the absolute value.

The hundred-seventh invention for solving the above-mentioned problems is characterized in, in one of the foregoing inventions, assuming the predetermined initial value to be 0 (zero).

The hundred-eighth invention for solving the above-mentioned problems is characterized in, in one of the foregoing inventions, decreasing the accumulation information at the time of having received a signal for giving an instruction for decreasing the radio resource quantity.

The hundred-ninth invention for solving the above-mentioned problems is characterized in, in one of the foregoing inventions, upon receipt of a signal for notifying a request for changing the radio resource quantity that the above mobile station may use from a first base station, updating the accumulation information based upon its result, and not changing the accumulation information notwithstanding reception of a signal from the base stations other than the first base station, which is for notifying a decrease in the radio resource quantity that the above mobile station may use.

The hundred-tenth invention for solving the above-mentioned problems, which is a signal transmission method in a communication station of radio communication system, is characterized in including: a step of receiving from a base station a signal for notifying a request for changing a radio resource quantity that its own station may use; a step of, when the signal is a signal from the base station performing scheduling for the radio resource quantity of its own station, updating the accumulation information based upon its result; and a step of updating the radio resource quantity that its own station may use responding to the signal, the accumulation information of the signal, and the radio resource quantity used ahead of a predetermined time.

The hundred-eleventh invention for solving the above-mentioned problems is characterized in, in one of the foregoing inventions, not changing the accumulation information in a case where a transmission format used ahead of the predetermined time does not belong to a subset of a predetermined transmission format.

The hundred-twelfth invention for solving the above-mentioned problems is characterized in that, in one of the foregoing inventions, only in a case where a transmission format used ahead of the predetermined time belongs to a subset of a predetermined transmission format, increasing the accumulation information based upon reception of a signal for giving an instruction for increasing the radio resource quantity.

The hundred-thirteenth invention for solving the above-mentioned problems is characterized in, in one of the foregoing inventions, in a case where a transmission format used ahead of the predetermined time does not belong to a subset of a predetermined transmission format, assuming the accumulation information to be 0 (zero) at the time of having received a signal for giving an instruction for decreasing the radio resource quantity.

The hundred-fourteenth invention for solving the above-mentioned problems is characterized in that, in one of the foregoing inventions, the transmission format is an E-TFC.

The hundred-fifteenth invention for solving the above-mentioned problems is characterized in that, in one of the foregoing inventions, the so-called radio resource quantity is a value associated with a transmission power of a radio communication channel.

The hundred-sixteenth invention for solving the above-mentioned problems is characterized in that, in one of the foregoing inventions, the so-called radio resource quantity is a power offset of an uplink channel from its own station to the other stations.

The hundred-seventeenth invention for solving the above-mentioned problems is characterized in that, in one of the foregoing inventions, the mobile station assumes that the power offset of the uplink channel from its own station to the other stations is a power offset for the transmission power of the individual channel controlled by a closed loop transmission power control so that it has a predetermined reception quality.

The hundred-eighteenth invention for solving the above-mentioned problems is characterized in, in one of the foregoing inventions, not increasing the accumulation information in a case where the accumulation information has reached a predetermined maximum value.

The hundred-nineteenth invention for solving the above-mentioned problems, which is a signal transmission method in a communication station of a radio communication system, is characterized in including a step of receiving from a base station s signal for relatively controlling a permitted radio resource quantity of its own station, and a step of updating the permitted radio resource quantity responding to the control signal, a result of requesting a change to the permitted radio resource quantity, and magnitude of the radio resource quantity used ahead of a predetermined time.

The hundred-twentieth invention for solving the above-mentioned problems is characterized in, in one of the foregoing inventions, further including a step of transmitting a signal to the base station from its own station with the radio resource quantity equal to or less than the permitted radio resource quantity that has been updated.

The hundred-twenty-first invention for solving the above-mentioned problems is characterized in that, in one of the foregoing inventions, the so-called radio resource quantity is a value associated with a transmission power of a radio communication channel.

The hundred-twenty-second invention for solving the above-mentioned problems is characterized in, in one of the foregoing inventions, the so-called radio resource quantity is a power offset of an uplink channel from its own station to the base station.

The hundred-twenty-third invention for solving the above-mentioned problems is characterized in, in one of the foregoing inventions, assuming that the power offset of the uplink channel is a power offset for the transmission power of the individual channel controlled by a closed loop transmission power control so that it has a predetermined reception quality.

The hundred-twenty-fourth invention for solving the above-mentioned problems, which is a communication station in a radio communication system, is characterized in including a means for receiving from the other communication stations a signal for notifying a request for changing the radio resource quantity that its own station may use, and an updating means for updating the radio resource quantity that its own station may use responding to the signal, accumulation information of the signal, and the radio resource quantity used ahead of a predetermined time.

The hundred-twenty-fifth invention for solving the above-mentioned problems is characterized in, in one of the foregoing inventions, further including an accumulation information measuring means for measuring as the accumulation information the number of times in the case that a transmission format of the signal from its own station to the other communication stations selected based upon a result of receiving a signal for giving an instruction for increasing the radio resource quantity of the its own station is identical to a transmission format of the signal used ahead of a predetermined time.

The hundred-twenty-sixth invention for solving the above-mentioned problems is characterized in, in one of the foregoing inventions, further including an accumulation information measuring means for increasing the accumulation information when the radio resource quantity updated based upon reception of the signal for giving an instruction for increasing the radio resource quantity is identical to the radio resource quantity that existed ahead of a predetermined time.

The hundred-twenty-seventh invention for solving the above-mentioned problems is characterized in, in one of the foregoing inventions, further including an accumulation information measuring means for increasing the accumulation information when the radio resource quantity updated based upon reception of the signal for giving an instruction for increasing the radio resource quantity is identical to a value based upon the radio resource quantity that existed ahead of a predetermined time and the accumulation information.

The hundred-twenty-eighth invention for solving the above-mentioned problems is characterized in, in one of the foregoing inventions, further including an accumulation information measuring means for increasing the accumulation information when the radio resource quantity updated based upon reception of the signal for giving an instruction for increasing the radio resource quantity is identical to a value obtained by subtracting the accumulation information from the radio resource quantity.

The hundred-twenty-ninth invention for solving the above-mentioned problems is characterized in, in one of the foregoing inventions, further including an accumulation information measuring means for receiving a signal for giving an instruction for increasing the radio resource quantity, and increasing the accumulation information when a transmission format selected based upon the signal is identical to a transmission format used ahead of a predetermined time.

The hundred-thirtieth invention for solving the above-mentioned problems is characterized in that, in one of the foregoing inventions, the accumulation information measuring means resets the accumulation information to a predetermined initial value at the time of having received a signal for giving an instruction for decreasing the radio resource quantity.

The hundred-thirty-first invention for solving the above-mentioned problems is characterized in, in one of the foregoing inventions, further including: a transmitting means for transmitting a signal with radio resource quantity equal to or less than the updated radio resource quantity; a transmission power measuring unit for measuring a power with which the transmitting means has transmitted the signal, and a selecting means for selecting a transmission format of the signal being transmitted from the transmitting means based upon a measurement result by the transmission power measuring unit and the radio resource quantity updated by the updating means that the mobile station may use.

The hundred-thirty-second invention for solving the above-mentioned problems is characterized in that, in one of the foregoing inventions, the accumulation information measuring means resets the accumulation information to a predetermined initial value in a case where the selecting means having selected a transmission format different from the transmission format used ahead of the predetermined time.

The hundred-thirty-third invention for solving the above-mentioned problems is characterized in that, in one of the foregoing inventions, the accumulation information measuring means resets the accumulation information to a predetermined initial value when the radio resource quantity that the communication station may use differs from the radio resource quantity used ahead of the predetermined time.

The hundred-thirty-fourth invention for solving the above-mentioned problems is characterized in that, in one of the foregoing inventions, the accumulation information measuring means resets the accumulation information to a predetermined initial value when the radio resource quantity updated based upon reception of a signal for giving an instruction for increasing the radio resource quantity differs from a value obtained by subtracting the accumulation information from the radio resource quantity.

The hundred-thirty-fifth invention for solving the above-mentioned problems is characterized in that, in one of the foregoing inventions, the accumulation information measuring means includes a means for receiving from the other communication stations information corresponding to an absolute value of the radio resource quantity that its own station may use, and resets the accumulation information to a predetermined initial value upon receipt of the information corresponding to the absolute value.

The hundred-thirty-sixth invention for solving the above-mentioned problems is characterized in, in one of the foregoing inventions, assuming the predetermined initial value to be 0 (zero).

The hundred-thirty-seventh invention for solving the above-mentioned problems is characterized in that, in one of the foregoing inventions, the accumulation information measuring means decreases the accumulation information at the time of having received a signal for giving an instruction for decreasing the radio resource quantity.

The hundred-thirty-eighth invention for solving the above-mentioned problems is characterized in that, in one of the foregoing inventions, the accumulation information measuring means, upon receipt of a signal for notifying a request for changing the radio resource quantity that its own station may use from a first communication station, updates the accumulation information based upon its result, and does not change the accumulation information notwithstanding reception of a signal from the communication stations other than the first communication station, which is for notifying a decrease in the radio resource quantity that its own station may use.

The hundred-thirty-ninth invention for solving the above-mentioned problems, which is a communication station in a radio communication system, is characterized in including: a means for receiving from other communication stations a signal for notifying a request for changing a radio resource quantity that its own station may use; a measuring means for, when the signal is a signal from the other communication stations performing scheduling for the radio resource quantity of its own station, which is for notifying a request for changing the radio resource quantity that its own station may use, measuring accumulation information based upon its result; and an updating means for updating the radio resource quantity that its own station may use responding to the signal, the accumulation information of the signal, and the radio resource quantity used ahead of a predetermined time.

The hundred-fortieth invention for solving the above-mentioned problems is characterized in, in one of the foregoing inventions, not changing the accumulation information in a case where a transmission format used ahead of the predetermined time does not belong to a subset of a predetermined transmission format.

The hundred-forty-first invention for solving the above-mentioned problems is characterized in that, in one of the foregoing inventions, only in a case where a transmission format used ahead of the predetermined time belongs to a subset of a predetermined transmission format, the mobile station increases the accumulation information based upon reception of a signal for giving an instruction for increasing the radio resource quantity.

The hundred-forty-second invention for solving the above-mentioned problems is characterized in that, in one of the foregoing inventions, in a case where a transmission format used ahead of the predetermined time does not belong to a subset of a predetermined transmission format, the mobile station assumes the accumulation information to be 0 (zero) at the time of having received a signal for giving an instruction for decreasing the radio resource quantity.

The hundred-forty-third invention for solving the above-mentioned problems is characterized in that, in one of the foregoing inventions, the transmission format is an E-TFC.

The hundred-forty-fourth invention for solving the above-mentioned problems is characterized in that, in one of the foregoing inventions, the so-called radio resource quantity is a value associated with a transmission power of a radio communication channel.

The hundred-forty-fifth invention for solving the above-mentioned problems is characterized in that, in one of the foregoing inventions, the so-called radio resource quantity is a power offset of an uplink channel from its own station to the other communication stations.

The hundred-forty-sixth invention for solving the above-mentioned problems is characterized in, in one of the foregoing inventions, assuming that the power offset of the channel from its own station to the other communication stations is a power offset for the transmission power of the individual channel controlled by a closed loop transmission power control so that it has a predetermined reception quality.

The hundred-forty-seventh invention for solving the above-mentioned problems is characterized in, in one of the foregoing inventions, not increasing the accumulation information in a case where the accumulation information has reached a predetermined maximum value.

The hundred-forty-eighth invention for solving the above-mentioned problems, which is a communication station in a radio communication system, is characterized in including a means for receiving from other communication stations a signal for relatively controlling a permitted radio resource quantity of its own station and a means for updating the permitted radio resource quantity responding to the control signal, a result of requesting a change to the permitted radio resource quantity, and magnitude of the radio resource quantity used ahead of a predetermined time.

The hundred-forty-ninth invention for solving the above-mentioned problems is characterized in, in one of the foregoing inventions, further including a means for transmitting a signal with the radio resource quantity equal to or less than the permitted radio resource quantity that has been updated.

The hundred-fiftieth invention for solving the above-mentioned problems is characterized in that, in one of the foregoing inventions, the so-called radio resource quantity is a value associated with a transmission power of a radio communication channel.

The hundred-fifty-first invention for solving the above-mentioned problems is characterized in, in one of the foregoing inventions, the so-called radio resource quantity is a power offset of an uplink channel from its own station to the other communication stations.

The hundred-fifty-second invention for solving the above-mentioned problems is characterized in, in one of the foregoing inventions, assuming that the power offset of the channel from its own station to the other communication stations is a power offset for the transmission power of the individual channel controlled by a closed loop transmission power control so that it has a predetermined reception quality.

The hundred-fifty-third invention for solving the above-mentioned problems, which is a communication station in a radio communication system, is characterized in including a means for receiving from the other communication stations a signal for relatively controlling a permitted radio resource quantity of its own station, and an updating means for updating the permitted radio resource quantity responding to the control signal, a result of requesting a change to the permitted radio resource quantity, and magnitude of the radio resource quantity used ahead of a predetermined time.

The hundred-fifty-fourth invention for solving the above-mentioned problems is characterized in, in one of the foregoing inventions, further including a means for transmitting a signal with the radio resource quantity equal to or less than the permitted radio resource quantity that has been updated.

The hundred-fifty-fifth invention for solving the above-mentioned problems, which is a communication station, is characterized in transmitting to the other communication stations a signal for notifying a request for changing the radio resource quantity that the above other communication stations may use.

The hundred-fifty-sixth invention for solving the above-mentioned problems, which is a signal transmission method in a communication station of a radio communication system, is characterized in including a step of receiving from the other communication stations a signal for notifying a request for changing a radio resource quantity that its own station may use, and a step of updating the radio resource quantity that the its own station may use responding to the signal, accumulation information of the signal, and the radio resource quantity used ahead of a predetermined time.

The hundred-fifty-seventh invention for solving the above-mentioned problems is characterized in, in one of the foregoing inventions, further including a step of transmitting a signal with a radio resource quantity equal to or less than the updated radio resource quantity.

The hundred-fifty-eighth invention for solving the above-mentioned problems is characterized in that, in one of the foregoing inventions, the so-called accumulation information is information associated with the number of times in the case that a transmission format of the signal from the communication station to the other communication stations selected based upon a result of receiving a signal for giving an instruction for increasing the radio resource quantity is identical to a transmission format of the signal used ahead of a predetermined time.

The hundred-fifty-ninth invention for solving the above-mentioned problems is characterized in, in one of the foregoing inventions, further including a step of increasing the accumulation information when the radio resource quantity updated based upon a result of receiving the signal for giving an instruction for increasing the radio resource quantity is identical to the radio resource quantity that existed ahead of a predetermined time.

The hundred-sixtieth invention for solving the above-mentioned problems is characterized in, in one of the foregoing inventions, further including a step of increasing the accumulation information when the radio resource quantity updated based upon reception of the signal for giving an instruction for increasing the radio resource quantity is identical to a value based upon the radio resource quantity that existed ahead of a predetermined time and the accumulation information.

The hundred-sixty-first invention for solving the above-mentioned problems is characterized in, in one of the foregoing inventions, further including a step of increasing the accumulation information when the radio resource quantity updated based upon reception of the signal for giving an instruction for increasing the radio resource quantity is identical to a value obtained by subtracting the accumulation information from the radio resource quantity.

The hundred-sixty-second invention for solving the above-mentioned problems is characterized in, in one of the foregoing inventions, further including a step of receiving a signal for giving an instruction for increasing the radio resource quantity, and increasing the accumulation information when a transmission format selected based upon the signal is identical to a transmission format used ahead of a predetermined time.

The hundred-sixty-third invention for solving the above-mentioned problems is characterized in, in one of the foregoing inventions, resetting the accumulation information to a predetermined initial value at the time of having received a signal for giving an instruction for decreasing the radio resource quantity.

The hundred-sixty-fourth invention for solving the above-mentioned problems is characterized in, in one of the foregoing inventions, resetting the accumulation information to a predetermined initial value in a case of having selected a transmission format different from the transmission format used ahead of the predetermined time.

The hundred-sixty-fifth invention for solving the above-mentioned problems is characterized in, in one of the foregoing inventions, resetting the accumulation information to a predetermined initial value when the radio resource quantity that its own station may use differs from the radio resource quantity used ahead of the predetermined time.

The hundred-sixty-sixth invention for solving the above-mentioned problems is characterized in, in one of the foregoing inventions, resetting the accumulation information to a predetermined initial value when the radio resource quantity updated based upon reception of a signal for giving an instruction for increasing the radio resource quantity differs from a value obtained by subtracting the accumulation information from the radio resource quantity.

The hundred-sixty-seventh invention for solving the above-mentioned problems is characterized in, in one of the foregoing inventions, including a step of receiving from the other communication stations information corresponding to an absolute value of the radio resource quantity that its own station may use, and resetting the accumulation information to a predetermined initial value upon receipt of the information corresponding to the absolute value.

The hundred-sixty-eighth invention for solving the above-mentioned problems is characterized in, in one of the foregoing inventions, assuming the predetermined initial value to be 0 (zero).

The hundred-sixty-ninth invention for solving the above-mentioned problems is characterized in, in one of the foregoing inventions, decreasing the accumulation information at the time of having received a signal for giving an instruction for decreasing the radio resource quantity.

The hundred-seventieth invention for solving the above-mentioned problems is characterized in, in one of the foregoing inventions, upon receipt of a signal for notifying a request for changing the radio resource quantity that its own station may use from a first communication station, updating the accumulation information based upon its result, and not changing the accumulation information notwithstanding reception of a signal from the communication stations other than the first communication station, which is for notifying a decrease in the radio resource quantity that its own station may use.

The hundred-seventy-first invention for solving the above-mentioned problems, which is a signal transmission method in a communication station of a radio communication system, is characterized in including: a step of receiving from other communication stations a signal for notifying a request for changing a radio resource quantity that its own station may use; a step of, when the signal is a signal from the other communication stations performing scheduling for the radio resource quantity of its own station, updating accumulation information based upon its result; and a step of updating the radio resource quantity that its own station may use responding to the signal, the accumulation information of the signal, and the radio resource quantity used ahead of a predetermined time.

The hundred-seventy-second invention for solving the above-mentioned problems is characterized in, in one of the foregoing inventions, not changing the accumulation information in a case where a transmission format used ahead of the predetermined time does not belong to a subset of a predetermined transmission format.

The hundred-seventy-third invention for solving the above-mentioned problems is characterized in, in one of the foregoing inventions, only in a case where a transmission format used ahead of the predetermined time belongs to a subset of a predetermined transmission format, increasing the accumulation information based upon reception of a signal for giving an instruction for increasing the radio resource quantity.

The hundred-seventy-fourth invention for solving the above-mentioned problems is characterized in, in one of the foregoing inventions, in a case where a transmission format used ahead of the predetermined time does not belong to a subset of a predetermined transmission format, assuming the accumulation information to be 0 (zero) at the time of having received a signal for giving an instruction for decreasing the radio resource quantity.

The hundred-seventy-fifth invention for solving the above-mentioned problems is characterized in that, in one of the foregoing inventions, the transmission format is an E-TFC.

The hundred-seventy-sixth invention for solving the above-mentioned problems is characterized in that, in one of the foregoing inventions, the so-called radio resource quantity is a value associated with a transmission power of a radio communication channel.

The hundred-seventy-seventh invention for solving the above-mentioned problems is characterized in that, in one of the foregoing inventions, the so-called radio resource quantity is a power offset of an uplink channel from its own station to the other stations.

The hundred-seventy-eighth invention for solving the above-mentioned problems is characterized in that, in one of the foregoing inventions, the communication station assumes that the power offset of the uplink channel from its own station to the other communication stations is a power offset for the transmission power of the individual channel controlled by a closed loop transmission power control so that it has a predetermined reception quality.

The hundred-seventy-ninth invention for solving the above-mentioned problems is characterized in, in one of the foregoing inventions, not increasing the accumulation information in a case where the accumulation information has reached a predetermined maximum value.

The hundred-eightieth invention for solving the above-mentioned problems, which is a signal transmission method in communication station of a radio communication system, is characterized in including a step of receiving from other communication stations a signal for relatively controlling a permitted radio resource quantity of its own station, and a step of updating the permitted radio resource quantity responding to the control signal, a result of requesting a change to the permitted radio resource quantity, and magnitude of the radio resource quantity used ahead of a predetermined time.

The hundred-eighty-first invention for solving the above-mentioned problems is characterized in, in one of the foregoing inventions, further including a step of transmitting a signal with the radio resource quantity equal to or less than the permitted radio resource quantity that has been updated.

The hundred-eighty-second invention for solving the above-mentioned problems is characterized in that, in one of the foregoing inventions, the so-called radio resource quantity is a value associated with a transmission power of a radio communication channel.

The hundred-eighty-third invention for solving the above-mentioned problems is characterized in, in one of the foregoing inventions, the so-called radio resource quantity is a power offset of an uplink channel from its own station to the other communication stations.

The hundred-eighty-fourth invention for solving the above-mentioned problems is characterized in, in one of the foregoing inventions, assuming that the power offset of the uplink channel is a power offset for the transmission power of the individual channel controlled by a closed loop transmission power control so that it has a predetermined reception quality.

The hundred-eighty-fifth invention for solving the above-mentioned problems is characterized in that, in one of the foregoing inventions, the request for the change is one of requests for an increase in, a decrease in, and maintenance of the radio resource quantity.

The hundred-eighty-sixth invention for solving the above-mentioned problems, which is a signal transmission method in a radio communication system being configured at least of a base station and a mobile station, is characterized in that the base station includes a step of transmitting a signal for notifying a request for changing a radio resource quantity that the mobile station may use, and the mobile station includes: a step of receiving the signal; and a step of: in a case where the signal is a signal indicating an increase in the radio resource quantity, increasing the radio resource quantity of accumulation information when the value obtained by subtracting the radio resource quantity of the accumulation information from the radio resource quantity that the mobile station may use is identical to a value obtained by adding a predetermined radio resource quantity to the radio resource quantity used ahead of a predetermined time; when the value obtained by subtracting the radio resource quantity of the accumulation information from the radio resource quantity that the mobile station may use differs from a value obtained by adding a predetermined radio resource quantity to the radio resource quantity used ahead of a predetermined time, resetting the radio resource quantity of the accumulation information to a predetermined initial value; and assuming the value obtained by adding a predetermined radio resource quantity and the radio resource quantity of the accumulation information to the radio resource quantity used ahead of a predetermined time to be a radio resource quantity that the mobile station may use; a step of, in a case where the signal is a signal indicating a decrease in the radio resource quantity, assuming the value obtained by subtracting a predetermined radio resource quantity from the radio resource quantity used ahead of a predetermined time to be a radio resource quantity that the mobile station may use; and a step of making transmission by using the radio resource quantity that does not exceed the radio resource quantity that the mobile station may use.

The hundred-eighty-seventh invention for solving the above-mentioned problems, which is a radio communication system being configured at least of a base station and a mobile station, is characterized in that: the base station includes a means for transmitting a signal for notifying a request for changing a radio resource quantity that the mobile station may use; the mobile station includes a means for receiving the signal and an updating means for: in a case where the signal is a signal indicating an increase in the radio resource quantity, increasing the radio resource quantity of accumulation information when the value obtained by subtracting the radio resource quantity of the accumulation information from the radio resource quantity that the mobile station may use is identical to a value obtained by adding a predetermined radio resource quantity to the radio resource quantity used ahead of a predetermined time; when the value obtained by subtracting the radio resource quantity of the accumulation information from the radio resource quantity that the mobile station may use differs from a value obtained by adding a predetermined radio resource quantity to the radio resource quantity used ahead of a predetermined time, resetting the radio resource quantity of the accumulation information to a predetermined initial value; and assuming the value obtained by adding a predetermined radio resource quantity and the radio resource quantity of the accumulation information to the radio resource quantity used ahead of a predetermined time to be a radio resource quantity that the mobile station may use; and the updating means further includes a means for, in a case where the signal is a signal indicating a decrease in the radio resource quantity, assuming the value obtained by subtracting a predetermined radio resource quantity from the radio resource quantity used ahead of a predetermined time to be a radio resource quantity that the mobile station may use, and making transmission by using the radio resource quantity that does not exceed the radio resource quantity that the mobile station may use.

The hundred-eighty-eighth invention for solving the above-mentioned problems, which is a mobile station in a radio communication system, is characterized in that: the mobile station includes a means for receiving a signal, and an updating means for: in a case where the signal is a signal indicating an increase in the radio resource quantity, increasing the radio resource quantity of accumulation information when the value obtained by subtracting the radio resource quantity of the accumulation information from the radio resource quantity that the mobile station may use is identical to a value obtained by adding a predetermined radio resource quantity to the radio resource quantity used ahead of a predetermined time; when the value obtained by subtracting the radio resource quantity of the accumulation information from the radio resource quantity that the mobile station may use differs from a value obtained by adding a predetermined radio resource quantity to the radio resource quantity used ahead of a predetermined time, resetting the radio resource quantity of the accumulation information to a predetermined initial value; and assuming the value obtained by adding a predetermined radio resource quantity and the radio resource quantity of the accumulation information to the radio resource quantity used ahead of a predetermined time to be a radio resource quantity that the mobile station may use; and the updating means further includes a means for, in a case where the signal is a signal indicating a decrease in the radio resource quantity, assuming the value obtained by subtracting a predetermined radio resource quantity from the radio resource quantity used ahead of a predetermined time to be a radio resource quantity that the mobile station may use, and making transmission by using the radio resource quantity that does not exceed the radio resource quantity that the mobile station may use.

The hundred-eighty-ninth invention for solving the above-mentioned problems, which is a signal transmission method in a mobile station of a radio communication system, is characterized in including: a step of receiving from a base station a signal for notifying a request for changing a radio resource quantity that the mobile station may use; a step of: in a case where the signal is a signal indicating an increase in the radio resource quantity, increasing the radio resource quantity of accumulation information when the value obtained by subtracting the radio resource quantity of the accumulation information from the radio resource quantity that the mobile station may use is identical to a value obtained by adding a predetermined radio resource quantity to the radio resource quantity used ahead of a predetermined time; when the value obtained by subtracting the radio resource quantity of the accumulation information from the radio resource quantity that the mobile station may use differs from a value obtained by adding a predetermined radio resource quantity to the radio resource quantity used ahead of a predetermined time, resetting the radio resource quantity of the accumulation information to a predetermined initial value; and assuming the value obtained by adding a predetermined radio resource quantity and the radio resource quantity of the accumulation information to the radio resource quantity used ahead of a predetermined time to be a radio resource quantity that the mobile station may use; a step of, in a case where the signal is a signal indicating a decrease in the radio resource quantity, assuming the value obtained by subtracting a predetermined radio resource quantity from the radio resource quantity used ahead of a predetermined time to be a radio resource quantity that the mobile station may use; and a step of making transmission by using the radio resource quantity that does not exceed the radio resource quantity that the mobile station may use.

The hundred-ninetieth invention for solving the above-mentioned problems, which is a communication station in a radio communication system, is characterized in that: the communication station includes a means for receiving a signal, and an updating means for: in a case where the signal is a signal indicating an increase in the radio resource quantity, increasing the radio resource quantity of accumulation information when the value obtained by subtracting the radio resource quantity of the accumulation information from the radio resource quantity that its own station may use is identical to a value obtained by adding a predetermined radio resource quantity to the radio resource quantity used ahead of a predetermined time; when the value obtained by subtracting the radio resource quantity of the accumulation information from the radio resource quantity that its own station may use differs from a value obtained by adding a predetermined radio resource quantity to the radio resource quantity used ahead of a predetermined time, resetting the radio resource quantity of the accumulation information to a predetermined initial value; and assuming the value obtained by adding a predetermined radio resource quantity and the radio resource quantity of the accumulation information to the radio resource quantity used ahead of a predetermined time to be a radio resource quantity that its own station may use; and the updating means further includes a means for, in a case where the signal is a signal indicating a decrease in the radio resource quantity, assuming the value obtained by subtracting a predetermined radio resource quantity from the radio resource quantity used ahead of a predetermined time to be a radio resource quantity that the its own station may use, and making transmission by using the radio resource quantity that does not exceed the radio resource quantity that the its own station may use.

The hundred-ninety-first invention for solving the above-mentioned problems, which is a signal transmission method in a communication station of a radio communication system, is characterized in including: a step of receiving from a base station a signal for notifying a request for changing a radio resource quantity that its own station may use; a step of: in a case where the signal is a signal indicating an increase in the radio resource quantity, increasing the radio resource quantity of accumulation information when the value obtained by subtracting the radio resource quantity of the accumulation information from the radio resource quantity that its own station may use is identical to a value obtained by adding a predetermined radio resource quantity to the radio resource quantity used ahead of a predetermined time; when the value obtained by subtracting the radio resource quantity of the accumulation information from the radio resource quantity that its own station may use differs from a value obtained by adding a predetermined radio resource quantity to the radio resource quantity used ahead of a predetermined time, resetting the radio resource quantity of the accumulation information to a predetermined initial value; and assuming the value obtained by adding a predetermined radio resource quantity and the radio resource quantity of the accumulation information to the radio resource quantity used ahead of a predetermined time to be a radio resource quantity that its own station may use; a step of, in a case where the signal is a signal indicating a decrease in the radio resource quantity, assuming the value obtained by subtracting a predetermined radio resource quantity from the radio resource quantity used ahead of a predetermined time to be a radio resource quantity that its own station may use; and a step of making transmission by using the radio resource quantity that does not exceed the radio resource quantity that its own station may use.

The hundred-ninety-second invention for solving the above-mentioned problems is characterized in that, in one of the foregoing inventions, the radio resource quantity is a power offset.

The hundred-ninety-third invention for solving the above-mentioned problems is characterized in that, in one of the foregoing inventions, the radio resource quantity is a power offset.

The hundred-ninety-fourth invention for solving the above-mentioned problems is characterized in that, in one of the foregoing inventions, the radio resource quantity is a SG index.

The hundred-ninety-fifth invention for solving the above-mentioned problems is characterized in that a signal transmission method in a radio communication system being configured at least of a first communication station and a second communication station, characterized in that: said first communication station comprises a step of transmitting a signal for notifying a request for changing a radio resource quantity that said second communication station may use; and said second communication station comprises a step of receiving said signal and a step of updating the radio resource quantity that said second communication station may use responding to said signal, accumulation information of said signal, and the radio resource quantity used ahead of a predetermined time.

The hundred-ninety-sixth invention for solving the above-mentioned problems is characterized in that, in one of the foregoing inventions, said second communication station further comprises a step of transmitting a signal with a radio resource quantity equal to or less than said updated radio resource quantity.

The hundred-ninety-seventh invention for solving the above-mentioned problems is characterized in that, in one of the foregoing inventions, said second communication station further comprises a step of increasing said accumulation information when a transmission format of the signal from said second communication station to said first communication station selected by said second communication station based upon a result of receiving a signal for giving an instruction for increasing said radio resource quantity is identical to a transmission format of the signal used ahead of a predetermined time.

The hundred-ninety-eighth invention for solving the above-mentioned problems is characterized in that, in one of the foregoing inventions, said second communication station further comprises a step of increasing said accumulation information when the radio resource quantity updated based upon reception of a signal for giving an instruction for increasing said radio resource quantity is identical to the radio resource quantity that existed ahead of a predetermined time.

The hundred-ninety-ninth invention for solving the above-mentioned problems is characterized in that, in one of the foregoing inventions, said second communication station further comprises the steps of: transmitting a signal with a radio resource quantity; equal to or less than said updated radio resource quantity; measuring a power with which a signal has been transmitted; and selecting a transmission format of the signal based upon said measured power and said updated radio resource quantity.

The two hundredth invention for solving the above-mentioned problems is characterized in that, in one of the foregoing inventions, said second communication station resets said accumulation information to a predetermined initial value in a case of having selected a transmission format different from the transmission format used ahead of said predetermined time.

The two hundred-first invention for solving the above-mentioned problems is characterized in that, in one of the foregoing inventions, said second communication station resets said accumulation information to a predetermined initial value when the radio resource quantity that said second communication station may use differs from the radio resource quantity used ahead of said predetermined time.

The two hundred-second invention for solving the above-mentioned problems is characterized in that, in one of the foregoing inventions, said second communication station further comprises a step of, when the signal received from said first communication station is a signal from a first communication station performing scheduling for the radio resource quantity of said second communication station, which is for notifying a request for changing the radio resource quantity that the above second communication station may use, updating said accumulation information based upon its result.

The two hundred-third invention for solving the above-mentioned problems is characterized in that, in one of the foregoing inventions, only when the transmission format used ahead of said predetermined time belongs to a subset of a predetermined transmission format, said second communication station increases said accumulation information based upon reception of a signal for giving an instruction for increasing said radio resource quantity.

The two hundred-fourth invention for solving the above-mentioned problems is characterized in that a radio communication system being configured at least of a first communication station and a second communication station, characterized in that: said first communication station comprising a means for transmitting a signal for notifying a request for changing a radio resource quantity that said second communication station may use; said second communication station comprises a means for receiving said signal, and an updating means for updating the radio resource quantity that said second communication station may use responding to said signal, accumulation information of said signal, and the radio resource quantity used ahead of a predetermined time.

The two hundred-fifth invention for solving the above-mentioned problems is characterized in that, in one of the foregoing inventions, said second communication station further comprises a means for transmitting a signal with a radio resource quantity equal to or less than said updated radio resource quantity.

The two hundred-sixth invention for solving the above-mentioned problems is characterized in that, in one of the foregoing inventions, said second communication station further comprises an accumulation information measuring means for increasing said accumulation information when a transmission format of the signal from said first communication station to said second communication station selected by said second communication station based upon a result of receiving a signal for giving an instruction for increasing said radio resource quantity is identical to a transmission format of the signal used ahead of a predetermined time.

The two hundred-seventh invention for solving the above-mentioned problems is characterized in that, in one of the foregoing inventions, said second communication station further comprises an accumulation information measuring means for increasing said accumulation information when the radio resource quantity updated based upon reception of the signal for giving an instruction for increasing said radio resource quantity is identical to the radio resource quantity that existed ahead of a predetermined time.

The two hundred-eighth invention for solving the above-mentioned problems is characterized in that, in one of the foregoing inventions, said second communication station further comprises: a transmitting means for transmitting a signal with a radio resource quantity equal to or less than said updated radio resource quantity; a transmission power measuring unit for measuring a power with which said transmitting means has transmitted the signal; and a selecting means for selecting a transmission format of the signal from said transmitting means based upon a measurement result by said transmission power measuring unit and the radio resource quantity updated by said updating means that said second communication station may use.

The two hundred-ninth invention for solving the above-mentioned problems is characterized in that, in one of the foregoing inventions, said accumulation information measuring means of said second communication station resets said accumulation information to a predetermined initial value in a case where said selecting means has selected a transmission format different from the transmission format used ahead of said predetermined time.

The two hundred-tenth invention for solving the above-mentioned problems is characterized in that, in one of the foregoing inventions, said second communication station comprises a means for resetting said accumulation information to a predetermined initial value when the radio resource quantity that said second communication station may use differs from the radio resource quantity used ahead of said predetermined time.

The two hundred-tenth invention for solving the above-mentioned problems is characterized in that, in one of the foregoing inventions,

The two hundred-eleventh invention for solving the above-mentioned problems is characterized in that, in one of the foregoing inventions, said first communication station comprises a means for transmitting a signal for notifying a request for changing the radio resource quantity that said second communication station may use; said second communication station comprises: a means for receiving said signal; a measuring means for, when said signal is a signal from the first communication station performing scheduling for the radio resource quantity of said second communication station, which is for notifying a request for changing the radio resource quantity that the above second communication station may use, measuring said accumulation information based upon its result; and an updating means for updating the radio resource quantity that said second communication station may use responding to said signal, accumulation information of said signal, and the radio resource quantity used ahead of a predetermined time.

The two hundred-twelfth invention for solving the above-mentioned problems is characterized in that, in one of the foregoing inventions, only when the transmission format used ahead of said predetermined time belongs to a subset of a predetermined transmission format, said second communication station increases said accumulation information based upon reception of the signal for giving an instruction for increasing said radio resource quantity.

The two hundred-thirteenth invention for solving the above-mentioned problems is characterized in that, a communication station in a radio communication system, comprising: a means for receiving from other communication station a signal for notifying a request for changing a radio resource quantity that its own station may use; and an updating means for updating the radio resource quantity that its own station may use responding to said signal, accumulation information of said signal, and the radio resource quantity used ahead of a predetermined time.

The two hundred-fourteenth invention for solving the above-mentioned problems is characterized, in one of the foregoing inventions, in further comprising a transmitting means for transmitting a signal with a radio resource quantity equal to or less than said updated radio resource quantity.

The two hundred-fifteenth invention for solving the above-mentioned problems is characterized, in one of the foregoing inventions, in further comprising an accumulation information measuring means for measuring as said accumulation information the number of times in the case that a transmission format of the signal from its own station to other communication station selected based upon a result of receiving a signal for giving an instruction for increasing the radio resource quantity of said its own station is identical to a transmission format of the signal used ahead of a predetermined time.

The two hundred-sixteenth invention for solving the above-mentioned problems is characterized, in one of the foregoing inventions, in further comprising an accumulation information measuring means for increasing said accumulation information when the radio resource quantity updated based upon reception of the signal for giving an instruction for increasing said radio resource quantity is identical to the radio resource quantity that existed ahead of a predetermined time.

The two hundred-seventeenth invention for solving the above-mentioned problems is characterized, in one of the foregoing inventions, in further comprising: a transmitting means for transmitting a signal with a radio resource quantity equal to or less than said updated radio resource quantity; a transmission power measuring unit for measuring a power with which said transmitting means has transmitted the signal; and a selecting means for selecting a transmission format of the signal from said transmitting means based upon a measurement result by said transmission power measuring unit and the radio resource quantity updated by said updating means that said second communication station may use.

The two hundred-eighteenth invention for solving the above-mentioned problems is characterized in that, in one of the foregoing inventions, said accumulation information measuring means resets said accumulation information to a predetermined initial value in a case where said selecting means has selected a transmission format different from the transmission format used ahead of said predetermined time.

The two hundred-nineteenth invention for solving the above-mentioned problems is characterized in that, in one of the foregoing inventions, said accumulation information measuring means resets said accumulation information to a predetermined initial value when the radio resource quantity that said communication station may use differs from the radio resource quantity used ahead of said predetermined time.

The two hundred-twentieth invention for solving the above-mentioned problems is characterized, in one of the foregoing inventions, in comprising: a means for receiving from the other communication station a signal for notifying a request for changing the radio resource quantity that its own station may use; a measuring means for, when said signal is a signal from the other communication station performing scheduling for the radio resource quantity of its own station, which is for notifying a request for changing the radio resource quantity that its own station may use, measuring said accumulation information based upon its result; and an updating means for updating the radio resource quantity that its own station may use responding to said signal, accumulation information of said signal, and the radio resource quantity used ahead of a predetermined time.

The two hundred-twenty-first invention for solving the above-mentioned problems is characterized in that, in one of the foregoing inventions, only when the transmission format used ahead of said predetermined time belongs to a subset of a predetermined transmission format, said second communication station increases said accumulation information based upon reception of a signal for giving an instruction for increasing said radio resource quantity.

The two hundred-twenty-second invention for solving the above-mentioned problems is characterized in that a signal transmission method in a communication station of a radio communication system, comprising the steps of: receiving from other communication station a signal for notifying a request for changing a radio resource quantity that its own station may use; and updating the radio resource quantity that said second communication station may use responding to said signal, accumulation information of said signal, and the radio resource quantity used ahead of a predetermined time.

The two hundred-twenty-third invention for solving the above-mentioned problems is characterized in that a radio communication system being configured at least of a first communication station and a second communication station, characterized in that: said first communication station comprises a means for transmitting a signal for notifying a request for changing a radio resource quantity that said second communication station may use; said second communication station comprises: a means for receiving said signal; and an updating means for: in a case where said signal is a signal indicating an increase in the radio resource quantity, increasing the radio resource quantity of accumulation information when the value obtained by subtracting the radio resource quantity of the accumulation information from the radio resource quantity that said second communication station may use is identical to a value obtained by adding a predetermined radio resource quantity to the radio resource quantity used ahead of a predetermined time; when the value obtained by subtracting the radio resource quantity of the accumulation information from the radio resource quantity that said second communication station may use differs from a value obtained by adding a predetermined radio resource quantity to the radio resource quantity used ahead of a predetermined time, resetting the radio resource quantity of said accumulation information to a predetermined initial value; and assuming the value obtained by adding a predetermined radio resource quantity and the radio resource quantity of the accumulation information to the radio resource quantity used ahead of a predetermined time to be a radio resource quantity that said second communication station may use; said updating means, when said signal is a signal indicating a decrease in the radio resource quantity, further assumes the value obtained by subtracting a predetermined radio resource quantity from the radio resource quantity used ahead of a predetermined time to be a radio resource quantity that said second communication station may use; and said second communication station comprises a means for making transmission by using the radio resource quantity that does not exceed said radio resource quantity that may be used.

The two hundred-twenty-fourth invention for solving the above-mentioned problems is characterized in that a communication station in a radio communication system, characterized in that: said communication station comprises: a means for receiving said signal; and an updating means for: in a case where said signal is a signal indicating an increase in the radio resource quantity, increasing the radio resource quantity of accumulation information when the value obtained by subtracting the radio resource quantity of the accumulation information from the radio resource quantity that its own station may use is identical to a value obtained by adding a predetermined radio resource quantity to the radio resource quantity used ahead of a predetermined time; when the value obtained by subtracting the radio resource quantity of accumulation information from the radio resource quantity that its own station may use differs from a value obtained by adding a predetermined radio resource quantity to the radio resource quantity used ahead of a predetermined time, resetting the radio resource quantity of said accumulation information to a predetermined initial value; and assuming the value obtained by adding a predetermined radio resource quantity and the radio resource quantity of the accumulation information to the radio resource quantity used ahead of a predetermined time to be a radio resource quantity that its own station may use; said updating means, when said signal is a signal indicating a decrease in the radio resource quantity, further assumes the value obtained by subtracting a predetermined radio resource quantity from the radio resource quantity used ahead of a predetermined time to be a radio resource quantity that said its own station may use; and said its own station comprises a means for making transmission by using the radio resource quantity that does not exceed the radio resource quantity that may be used.

The two hundred-twenty-fifth invention for solving the above-mentioned problems is characterized in that a signal transmission method in a communication station of a radio communication system, characterized in comprising of: a step of receiving from a first communication station a signal for notifying a request for changing a radio resource quantity that its own station may use; a step of: in a case where said signal is a signal indicating an increase in the radio resource quantity, increasing the radio resource quantity of accumulation information when the value obtained by subtracting the radio resource quantity of the accumulation information from the radio resource quantity that its own station may use is identical to a value obtained by adding a predetermined radio resource quantity to the radio resource quantity used ahead of a predetermined time, and resetting the radio resource quantity of said accumulation information to a predetermined initial value when the value obtained by subtracting the radio resource quantity of the accumulation information from the radio resource quantity that its own station may use differs from a value obtained by adding a predetermined radio resource quantity to the radio resource quantity used ahead of a predetermined time; and assuming the value obtained by adding a predetermined radio resource quantity and the radio resource quantity of the accumulation information to the radio resource quantity used ahead of a predetermined time to be a radio resource quantity that its own station may use; a step of, when said signal is a signal indicating a decrease in the radio resource quantity, assuming the value obtained by subtracting a predetermined radio resource quantity from the radio resource quantity used ahead of a predetermined time to be a radio resource quantity that its own station may use; and a step of making transmission by using the radio resource quantity that does not exceed the radio resource quantity that its own station may use.

### An Advantageous Effect of the Invention

In accordance with the present invention, in a case where the radio resource is lacking for selecting the block size, which is larger by one, notwithstanding a base station's instruction for increasing a radio resources that may be used, by accumulating the number of times of the instruction for increasing the radio resources and adding an accumulation portion as well at the time of updating the radio resource that may be used at the next time, it becomes possible to select the block size that is larger by one. With this, it is possible to solve the point at issue that, in the related art, the identical transport block continues to be selected notwithstanding an instruction for increasing the radio resources, and resultantly, the transmission rate of the mobile station cannot be increased. Further, it is also possible to enhance the user throughput and to reduce a delay in the transmission because the transmission rate of the mobile station can be increased to a desired value.

### BRIEF DESCRIPTION OF THE DRAWINGS

FIG. 1 is a table illustrating one example of an E-TFC set being employed in the related art of the present invention.

FIG. 2 is a view for explaining a transport block being employed in the related art of the present invention.

FIG. 3 is a view illustrating a control procedure in the mobile station in the related art of the present invention.

FIG. 4 is a table illustrating one example of an SG table being employed in the related art of the present invention.

FIG. 5 is a view for explaining a method of controlling the SG in the related art of the present invention.

FIG. 6 is a view for explaining a configuration of the system that is common to all exemplary embodiments of the present invention.

FIG. 7 is a view illustrating an operational flow of the mobile station in a first exemplary embodiment of the present invention.

FIG. 8 is a view illustrating a configuration of the mobile station in the first exemplary embodiment of the present invention.

FIG. 9 is a view illustrating a configuration of the mobile station in the first exemplary embodiment of the present invention.

FIG. 10 is a view illustrating an operational flow of the mobile station in a third exemplary embodiment of the present invention.

FIG. 11 is a view illustrating an operational flow of the mobile station in a fourth exemplary embodiment of the present invention.

FIG. 12 is a view illustrating a configuration of the mobile station in a fifth exemplary embodiment of the present invention.

FIG. 13 is a view illustrating an operational flow of the mobile station in the fifth exemplary embodiment of the present invention.

FIG. 14 is a view for explaining a parameter set being employed in the background art of the present invention.

### DESCRIPTION OF NUMERALS

801 and 901 reception processing units

802 signal separating unit

803 SG updating unit

804 E-TFC selecting unit

805 ACC measuring unit

806 transmission power measuring unit

807 buffer

809 and 906 transmission processing units

902 reception power measuring unit

903 scheduler

904 error determining unit

905 control signal generating unit

### BEST MODE FOR CARRYING OUT THE INVENTION

### A First Exemplary Embodiment

The radio communication system in this exemplary embodiment is configured of plural base stations and plural mobile stations as shown in FIG. 6. The base station transmits a signal for notifying a request for changing the radio resource quantity (permitted radio resource quantity) that the mobile station may use.

The mobile station receives this signal for notifying a request for changing the permitted radio resource quantity, updates the radio resource quantity that the mobile station may use responding to the received request signal, accumulation information being obtained from a result of the request signal received so far, and the radio resource quantity used ahead of a predetermined time, and transmit the signal within a limit of its radio resource quantity. Herein, the radio resource quantity will be explained in details below by exemplifying the power offset of an uplink channel from the mobile station to the base station, in relation to configurations and operations of the mobile station and the base station.

Hereinafter, the radio resource quantity will be explained in details by exemplifying the power offset of the uplink channel from the mobile station to the base station, in relation to configurations and operations of the mobile station and the base station.

[A Configuration of the Mobile Station]

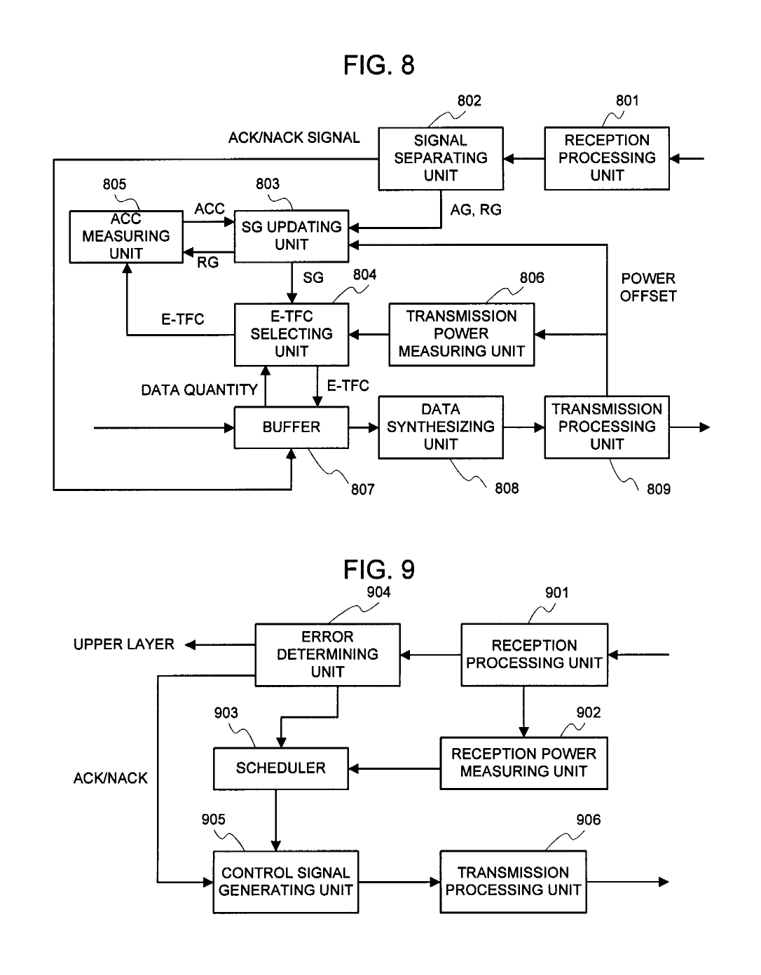

FIG. 8 is a view illustrating a configuration of the mobile station in this exemplary embodiment.

The mobile station in this exemplary embodiment is comprised of a reception processing unit 801, a signal separating unit 802, an SG updating unit 803, an E-TFC selecting unit 804, an ACC measuring unit 805, a transmission power measuring unit 806, a buffer 807, a data synthesizing unit 808, and a transmission processing unit 809.

The reception processing unit 801 receives signals of the DPCCH, the E-HICH, the E-AGCH, and the E-RGCH each of which is a downlink control signal channel, performs the processes necessary for reception, for example, RAKE synthesis and inverse diffusion, and sends the signals to the signal separating unit 802.

The signal separating unit 802 separates an AG and an RG, being control information necessary for updating the SG index, from the signals received in the reception processing unit 801, and sends them to the SG updating unit 803. The AG is a signal requiring the radio resource quantity (herein, a power offset) as an absolute value. The RG, which is a signal requiring that the radio resource quantity be relatively increased/decreased, is a signal for notifying a request for one of the increase (UP), the decrease (DOWN), and the maintenance (HOLD). Further, the signal separating unit 802 separates an ACK/NACK signal from the signals received in the reception processing unit 801, and sends it to the buffer 807.

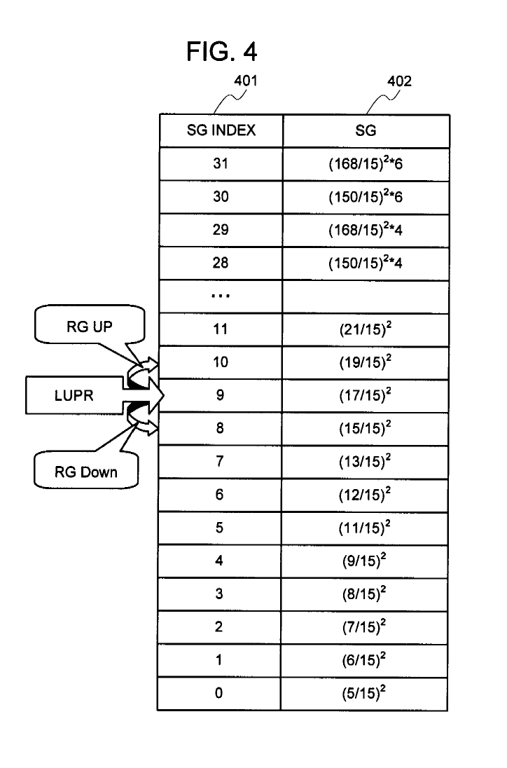

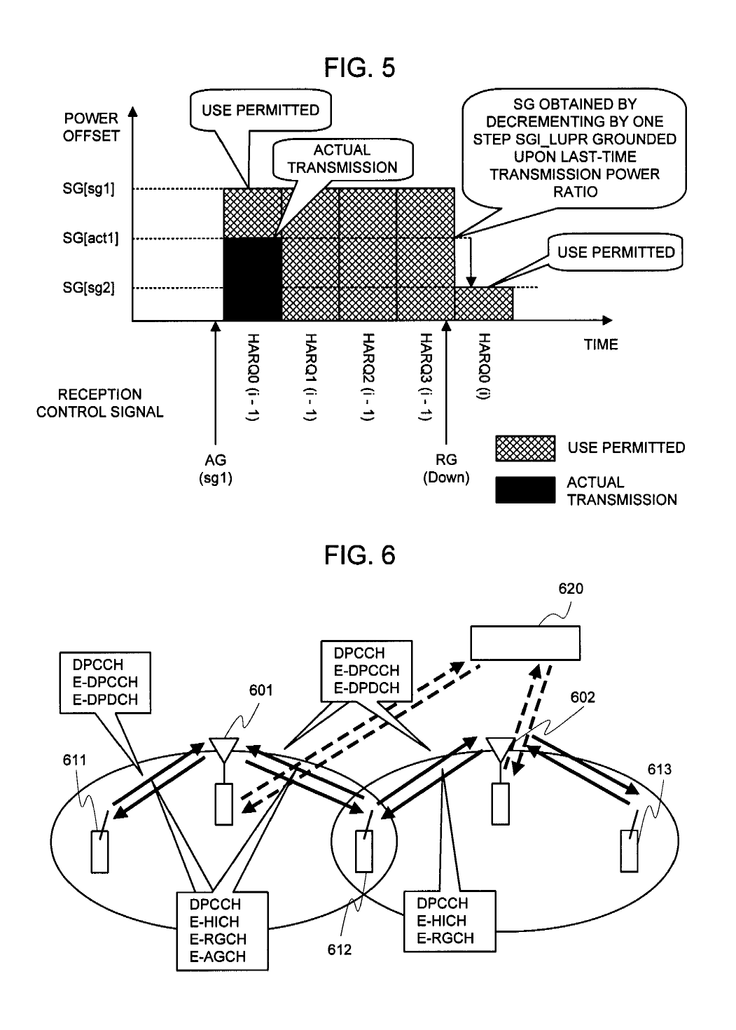

The SG updating unit 803, which preserves an SG table shown in FIG. 4, updates the SG to a SG having a value indicated by the AG upon receipt of the AG, updates the SG according to a procedure to be later described upon receipt of the RG, and sends the SG index indicating the updated SG to the E-TFC selecting unit 804.

The transmission power measuring unit 806 measures the power of the DPCCH that the transmission processing unit 809 transmits. In addition hereto, the transmission power measuring unit 806 calculates a remaining power of the mobile station by subtracting the power of the DPCCH and the power of the E-DPCCH being calculated therefrom from the maximum power.

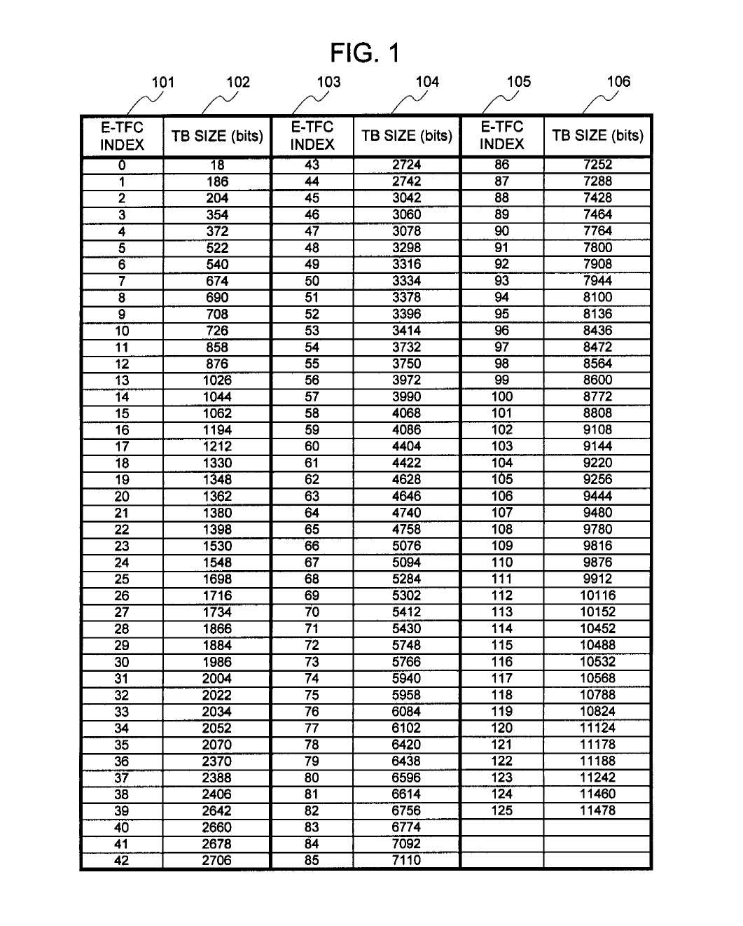

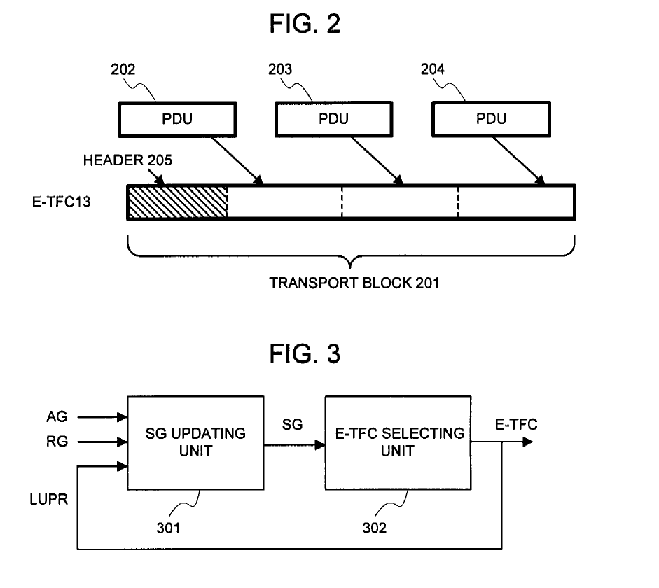

The E-TFC selecting unit 804 selects the minimum E-TFC, with which the data in the buffer can be transmitted as much as possible, out of the E-TFCs of which the power offset is equal to or less than the SG and yet which can be transmitted with the remaining power, from the E-TFC table of FIG. 1, based upon the SG and the transmission power of the DPCCH measured by the transmission power measuring unit 806, and selects it as an E-TFC of the next TTI transmission. The E-TFC selecting unit 804 notifies the selected E-FTC to the buffer 807, and notifies it to the ACC measuring unit 805.

The ACC measuring unit 805 accepts information of the received RG from the SG updating unit 803, and information of the selected E-TFC from the E-TFC selecting unit 804, compares the E-TFC transmitted last time in an identical HARQ process, which has been pre-recorded in a memory being included in the ACC measuring unit 805 that is not shown in the figure, with the E-TFC selected this time if the RG is UP, increments the ACC by one if they are identical to each other, and resets the ACC to zero if they differ from each other. The ACC measuring unit 805 resets the ACC to zero if the RG is DOWN.

On the other hand, the buffer 807 receives an ACK/NACK signal from the signal separating unit 802, receives predetermined retransmission data if the received signal is an NACK signal, and information associated with the E-FTC of the next TTI from the E-TFC selecting unit if the received signal is an ACK signal, respectively, and sends the PDUs of which the number is suited for the E-TFC to the data synthesizing unit, the data synthesizing unit 808 multiplexes the PDU into transport blocks, and executes the addition of a header hereto, the multiplexing of the control signal necessary for reception, or the like, and the transmission processing unit executes the necessary transmission processes such as encoding, diffusion, and demodulation, and transmits it.

[A Configuration of the Base Station]

FIG. 9 is a view illustrating a configuration of the base station being employed in this exemplary embodiment. The base station in this exemplary embodiment is comprised of a reception processing unit 901, a reception power measuring unit 902, a scheduler 903, an error determining unit 904, a control signal generating unit 905, and a transmission processing unit 906.

The reception processing unit 901 receives an uplink DPCCH, E-DPCCH, and E-DPDCH, performs the processes necessary for reception, for example, the RAKE synthesis and the inverse diffusion, the error determining unit 904 detects an error from a CRC of data received in the E-DPDCH, sends a detection result to the scheduler 903 as well as the control signal generating unit 905, and sends the data block in which no error has been detected to the upper layer. Further, the reception power measuring unit 902 measures the uplink reception power at a predetermined time period, and send a measurement result to the scheduler.

The scheduler compares the sent reception power with a reception power threshold being set by the upper layer, performs the scheduling for the mobile station based upon the error determination result so that all reception power does not exceed the threshold, and decides the power offset that each mobile station is permitted to use. This decision is sent to the control signal generating unit, in which the control signals such the an AG or the RG for notifying to each mobile station the power offset of which the use is permitted, and the ACK/NACK signal, being an error determination result, are generated. The control signal generating unit sends the generated control signals to the transmission processing unit 906, which performs the necessary transmission processes such as encoding, diffusion, and demodulation, and transmits it.

[A Flow in the Mobile Station]

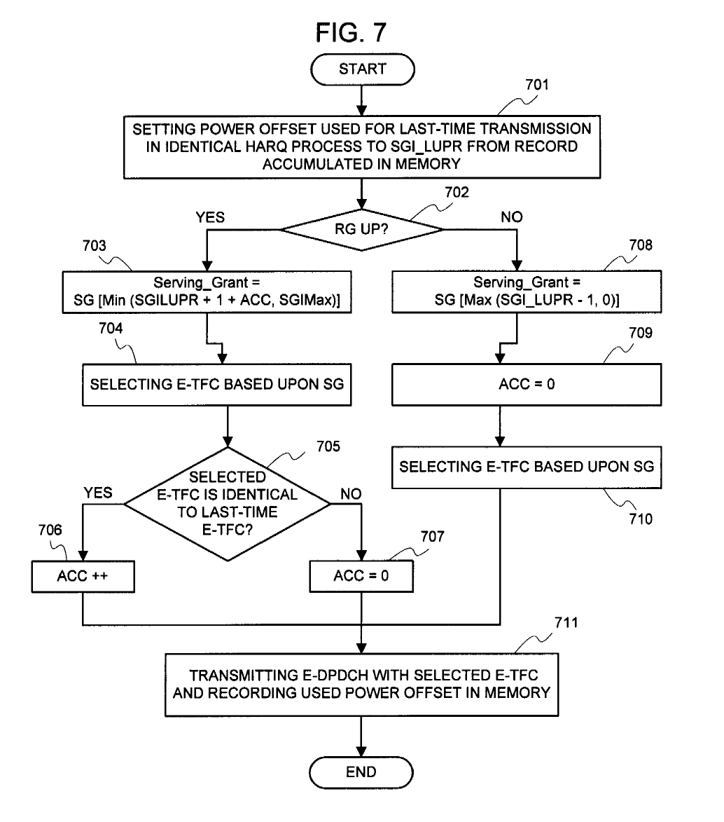

In FIG. 7, an operational flow in the case that the mobile station has received the RG is shown. Hereinafter, an operational flow in the case that the mobile station has received the RG will be explained by making a reference to FIG. 7 and FIG. 8.

Upon receipt of the RG, the SG updating unit 803 of the mobile station firstly selects the minimum power offset equivalent to or more than the power offset used for the last-time transmission (LUPR: Last Used Power Unit Ratio) in the identical ARQ process, which has accumulatively been recorded in the memory, from the power offset table, sets its index to SGI_LUPR (Step 701), updates the SG with following procedure, and selects the E-TFC. Herein, it is assumed that the maximum index, out of the indexes in the SG table, is SGI_max.

If the received RG is UP (Step 702, Yes):

The SG updating unit 803 calculates SERVING_GRANT, being a new SG, according to the following equation (Step 703).

SERVING_GRANT=SG[Min(SGI_LUPR+1+ACC, SGI_max)]

Herein, the ACC, which is a value associated with accumulation information of the RG, has been set to zero at the time of starting the transmission. It can be said safely that this ACC is a parameter indicating a result of requesting a change to the radio resource quantity that the mobile station may use, which has been notified to the mobile station from the base station.

Thereafter, the E-TFC selecting unit 804 selects the E-TFC based upon the new SG according to the procedure explained in the related art (step 704), the ACC measuring unit 805 increments the ACC by one in a case where the selected E-TFC is identical to the E-TFC used at the time of the last-time transmission in the identical HARQ process (Step 706), and resets the ACC to zero in a case the E-TFC different from the last-time E-TFC has been selected (step 707).

If the received RG is DOWN (Step 702, No):

The SG updating unit 803 calculates SERVING_GRANT, being a new SG, according to the following equation (Step 708).

SERVING_GRANT=SG[Max(SGLUPR−1,0)]

Further, the ACC measuring unit 805 resets the ACC to zero (Step 709). Thereafter, the E-TFC selecting unit selects the E-TFC based upon the new SG according to the procedure explained in the related art (step 710).

After selecting the E-TFC, the buffer 807 sends the DPUs of which the number corresponds to the selected E-TFC to the data synthesizing unit 808, the transmission processing unit 809 transmits the E-DPDCH, and the SG updating unit 803 records information associated with the used power offset into the memory (Step 711).

Herein, the selected E-TFC was used as a condition for updating the ACC in the Step 705 of FIG. 7; however an index SGI_CURRENT of the power offset, which is used for transmitting the selected E-TFC, or an actual power offset SG[SGI_CURRENT] may be used. That is, in the Step 705, if SGI_LUPR and SGI_CURRENT are identical to each other (YES), the Step 706 is performed, and if they differ from each other (NO), the Step 707 is performed. Further, with the power offset, if SG[SGI_LUPR] and SG[SGI_CURRENT] are identical to each other (YES), the Step 706 is performed, and if they differ from each other (NO), the Step 707 is performed.

Above, if the value of the SGI is lacking for selecting the E-TFC with which the PDUs of which the number is larger by one can be transmitted notwithstanding a notification saying UP of the RG, the ACC is incremented by one. That is, in a case where it was impossible to increase the E-TFC notwithstanding reception of UP by the RG, the number of times of the notification saying UP of the RG is accumulated, which is added to the SGT in the next step of updating the SG, thereby to solve the points at issue explained in the problems, and to enable an increase in the E-TFC by the RG. Thus, notwithstanding employment of the RG of which the overhead is smaller as compared with that of the AG, it becomes possible to increase the transmission rate to a desired value, and it also possible to enhance a throughput of the entirety of the system, to enhance of a user throughput, and to reduce a delay in the transmission of the mobile station.

Additionally, herein, the explanation was made on the premise that the mobile station, being one component of the hardware configuration shown in FIG. 8 executed the operational flow shown in FIG. 7, and it is also possible that a program stored in the memory within the mobile station, which is not shown in the figure, causes hardware having a function identical to that of the hardware configuration shown in FIG. 8 to execute the operational flow shown in FIG. 7.

### A Second Exemplary Embodiment

The mobile station in the second exemplary embodiment differs from that of the first exemplary embodiment in a point that the addition of the ACC by the ACC measuring unit 805 in the Step 706 of FIG. 7 is executed only in the case where a predetermined E-TFC subset has been selected. For example, the mobile station executes the addition of the ACC in a case where, in the ACC measuring unit 805 in the first exemplary embodiment, the E-TFC index of the E-TFC last time transmitted in the identical HARQ process, which has been recorded in the memory, is equal to or less than a predetermined value, and upon listing an example more specifically, in a case where the E-TFC index in the E-TFC table of FIG. 1 is 13 or less (E-TFC 13, E-TFC 12, E-TFC 11, etc.), and the mobile station leaves the ACC with its value set to zero as it stands in the case other it.

As explained in the problems, the point at issue that should be solved by the present invention often occurs if the E-TFC is small, whereby by executing the addition of the ACC with the E-TFC that causes the problem to occur, and by not executing the addition with the E-TFC other than the foregoing one, it becomes possible to alleviates the process burden that the ACC measuring unit 805 bears in some cases, and further, it also possible to prevent the erroneous operation such that the addition of the ACC of which the value is not zero is executed due to an operational error in the E-TFC notwithstanding a rule of executing the addition of the ACC of which the value is zero. An operation and an effect other than it are similar to that of the first exemplary embodiment.

Further, herein, a certain E-TFC and the E-TFCs of the E-TFC index is smaller than it are set as a subset, but in this exemplary embodiment, the subset is not limited hereto, and an E-TFC 4, an E-TFC 13 and an E-TFC 25 may be set as a subset, and the E-TFCs of which the E-TFC index exceeds 13 may be set as a subset.

### A Third Exemplary Embodiment

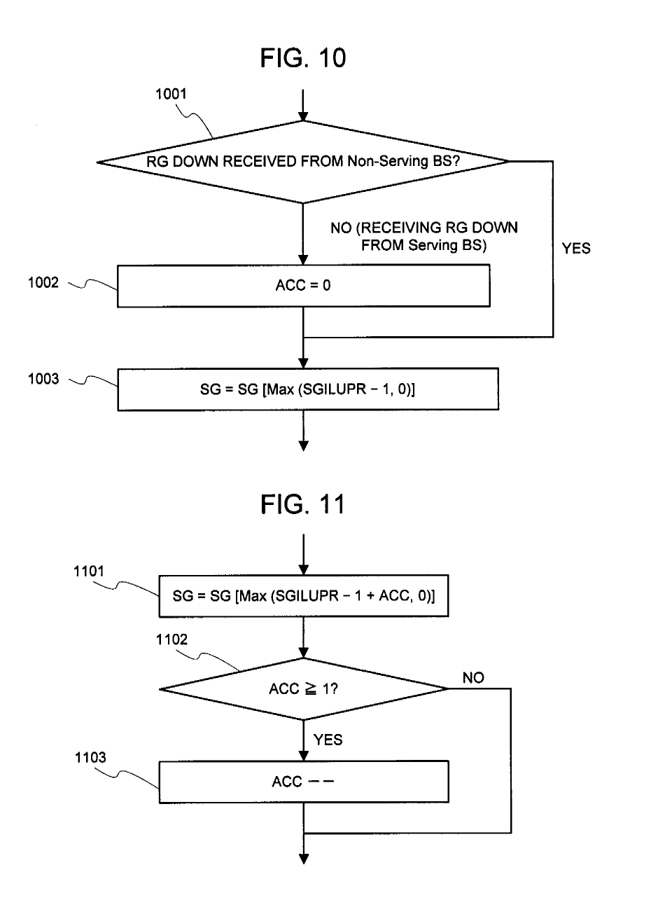

In the first and second exemplary embodiments, a configuration was made so that the ACC was set to zero in a case of having received DOWN of the RG, and the mobile station in the third exemplary embodiment is adapted to preserve the current value without resetting the ACC to zero in a case of having received a notification saying RG DOWN, which is transmitted by the base station (Non-serving BS) other than the base station (Serving BS) that performs the scheduling, while receiving the RGs from a plurality of the base stations. More specifically, the Steps 708 to 710 in FIG. 7 can be replaced with Steps 1001 to 1003 of FIG. 10. The mobile station resets the ACC (Step 1002) in a case of having received DOWN of the RG from the Serving BS (No in the Step 1001), but does not executes the Step 1002 in a case of having received DOWN of the RG from the Non-serving BS (Yes in the Step 1001). And, both in the case of Yes in the Step 1001 and in the case of No, the mobile station calculates SERVING_GRANT, being a new SG, according to the following equation (Step 1003).

SERVING_GRANT=SG[Max(SGI_LUPR−1,0)]

And, the mobile station selects the E-TFC based upon the SG (Step 1004).

As explained in the background art, in the EUDCH, the soft handover, which are received by a plurality of the base station is executed; however the Serving BS that can increase the SG by performing the scheduling is limited only to one base station. The Non-serving BS other than it can transmit RG DOWN (OLI: Over Load Indicator) for instructing the mobile stations, which are not performing the scheduling, to lower the SG in a case where the status of the reception power has come into an overload status of exceeding a predetermined condition, for example, in a case where all reception power of the base stations has become equal to or more than a predetermined threshold.

The mobile station, in a case of having received of this OLI, preferredly obeys this, and has to decrease the SG even though the Serving BS notifies UP of the SG. However, when the congestion in the Non-serving BS has been alleviated and the transmission of the OLI is stopped, the mobile station can obey the AG or the RG again being transmitted by the Serving BS.

At this time, resetting the ACC to zero whenever receiving RG DOWN irrespective of the Serving BS or the

Non-serving BS like the case of the first exemplary embodiment necessitates a re-start of accumulation in a stage of ACC=0 at the moment of increasing the power offset according to the RG of the Serving BS after congestion of the Non-serving BS is alleviated, which causes a delay required by the time the E-TFC of which E-TFC index is larger by one is selected to augment. Thereupon, in this exemplary embodiment, the effect that a delay required at the time the E-TFC of which E-TFC index is larger by one is selected is reduced, and an increase in the transmission rate is quickened can be obtained by maintaining the ACC as it stands without resetting the ACC to zero if the RG being transmitted by Non-serving BS is DOWN. An operation and an effect other than it are similar to that of the first exemplary embodiment.

### A Fourth Exemplary Embodiment

In the first embodiment, the mobile station was configured to reset the ACC to zero in a case of having received DOWN of the RG, and the mobile station in the fourth exemplary embodiment is characterized in decrementing the ACC by one if the value of the ACC is one or more at the time point of having received DOWN of the RG. That is, the Steps 708 and 709 of FIG. 7 can be replaced with Steps 1101 to 1103 of FIG. 11. In the case of No in the Step 704 of FIG. 7, the mobile station executes (Step 1101)

SERVING_GRANT=SG[SGI_LUPR−1+ACC]

And, in the case of ACC>=1 (Yes in the Step 1102), the mobile station executes ACC=ACC−1 (Step 1103) An operation and an effect other than it are similar to that of the first exemplary embodiment.

### A Fifth Exemplary Embodiment

The fifth exemplary embodiment, which differs from the first exemplary embodiment in the condition that is used for measuring the ACC, is identical to the first exemplary embodiment in the other than it, and a combination of the second to fourth exemplary embodiments and the fifth exemplary embodiment is also possible.

The point in which the fifth exemplary embodiment differs from the first exemplary embodiment will be explained below based upon a configuration of the mobile station and its operational flow.

[A Configuration of the Mobile Station]

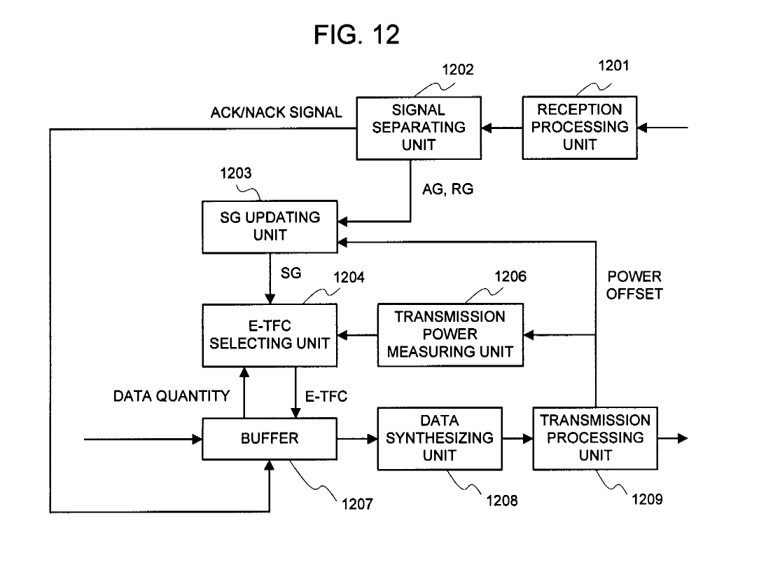

FIG. 12 is a view illustrating a configuration of the mobile station in this exemplary embodiment.

The point in which the mobile station in the fifth exemplary embodiment differs from the mobile station in the first exemplary embodiment is that the ACC measuring unit is not included in the mobile station in the fifth exemplary embodiment. Instead thereof, in the mobile station in the fifth exemplary embodiment, an SG updating unit 1203 measures the ACC.

The SG updating unit 1203, upon receipt of the AG, updates the SG to an SG having the value shown in the AG, updates the SG based upon the procedure of a flow of the mobile station to be later described upon receipt of the RG, and sends the updated SG to an E-TFC selecting unit 1204.

A transmission power measuring unit 1206 measures the power of the DPCCH being transmitted by a transmission processing unit 1209. In addition hereto, the transmission power measuring unit 1206 calculates a remaining power of the mobile station by subtracting from the maximum power the power of the DPCCH and the power of the E-DPCCH being calculated therefrom.

The E-TFC selecting unit 1204 selects the minimum E-TFC with which the data within the buffer can be transmitted as much as possible, out of the E-TFCs, of which the desired power offset is equal to or less than the SG, and yet, which can be transmitted with the remaining power, based upon the SG and the transmission power of the DPCCH measured by the transmission power measuring unit 1206.

[A Flow of the Mobile Station]

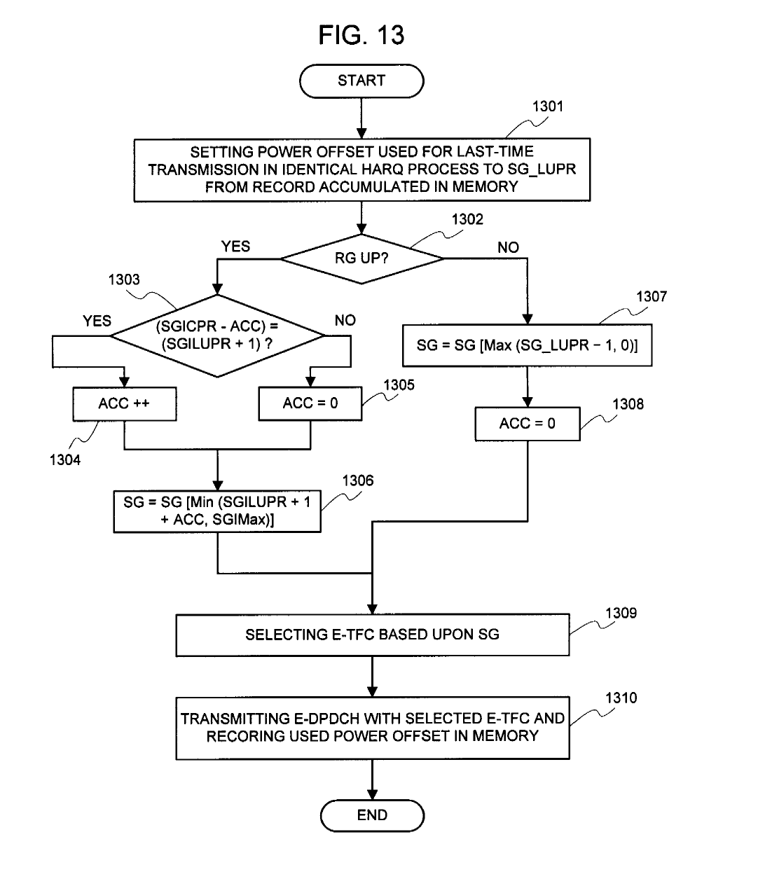

FIG. 13 is a view illustrating an operational flow in the case that the mobile station has received the RG in the fifth exemplary embodiment. Hereinafter, an operational flow in the case that the mobile station has received the RG will be explained by employing FIG. 13 and FIG. 12. Herein, if it is assumed that the maximum SG index, out of the SG indexes in the SG table, is SGI_max.

When the mobile station receives the RG,

Step 1301: the SG updating unit 1203 selects the minimum SG, which is equal to or more than the power offset (LUPR: Last Used Power Ratio) used in the last-time transmission in the identical HARQ process, from among the SGs in the SG table, and sets its index to SGI_LUPR.

Step 1302:

If the received RG is UP (Step 1302, YES):

Step 1303: the SG updating unit 1203 compares (SGI_CPR−ACC) with (SGI_LUPR+1) with an index of the current SG assumed to be SGI_CPR. Herein, the ACC, which is a value associated with accumulation information of the RG, has been set to zero at the time of starting the transmission.

If they are identical to each other (Step 1303, YES):

ACC++

If they differ from each other (Step 1303, No):

ACC=0

Step 1304: the SG updating unit sets either SG[SGILUPR+1+ACC] or SG[SGI_max], whichever is smaller, as an SG.

If the received RG is DOWN of the Serving RG, or the Non-serving RG (Step 1302, NO):

Step 1307: the SG updating unit 1203 sets either SG[SGILUPR1] or SG[0], whichever is larger, as an SG.

Step 1308: ACC=0

Step 1309: the E-TFC selecting unit 1204 selects the E-TFC based upon the updated SG according to the procedure explained in the related art.

Step 1310: the transmission processing unit 1209 transmits the E-DPDCH with the selected E-TFC, and the SG updating unit 1203 records information associated with the used power offset into the memory.

As mentioned above, in a case where the SG has not been increased as compared with last-time case notwithstanding reception of RG UP, incrementing the ACC, which is added to the SG being used for selecting the E-TFC, makes it possible to solve the points at issue as explained in the problems. Thus, an increase in the E-TFC is enabled with the RG, which can increase the transmission rate to a desired value notwithstanding employment of the RG having a small overhead, and it is impossible to enhance a throughput of the entirety of the system, to enhance a user throughput of the mobile station, and to reduce a delay in the transmission.

Additionally, in the first to fifth exemplary embodiments mentioned above, in the Step 706 of FIG. 7 illustrating the operational flow of the mobile station, the ACC was incremented by one in a case where the RG was UP, and yet this-time E-TFC was identical to the E-TFC last time transmitted in the identical HARQ process.

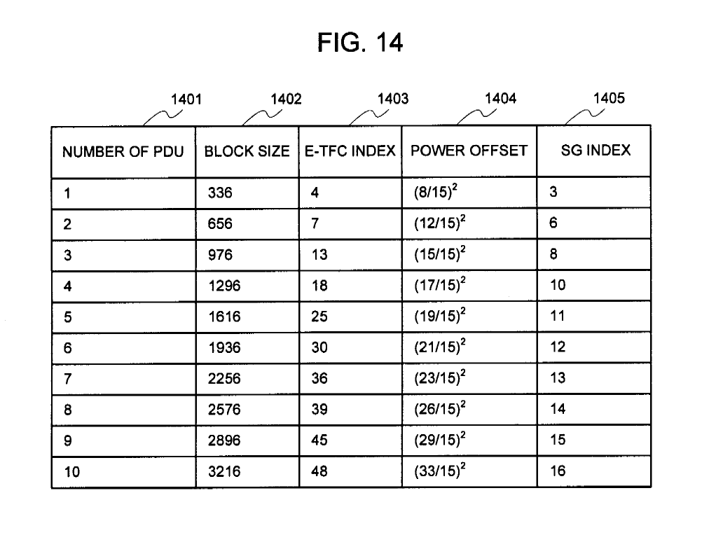

However, as mention in the explanation (3) associated with the E-TFC selection of the background art, the mobile station selects the minimum E-TFC, out of the E-TFCs with which the data quantity within buffer can be transmitted as much as possible. For example, it is assumed that the mobile station has received UP of the RG, and the SG has been updated to an SG that is indicated by the SG index 6, the mobile station can select the E-TFC 7 or the E-TFCs of which E-TFC index is larger with which two PDUs can be transmitted from FIG. 14. However, if it is assumed that the data quantity within the buffer is 300 bits, the mobile station select the E-TFC 4 with which one PDU can be transmitted because to send one PDU is enough for transmitting all data. Thus, the case occurs of not selecting the E-TFC of which the E-TFC index is larger than that of the last-time E-TFC notwithstanding reception of UP of the RG. In such a time, the addition of the ACC is not necessitated.

Specifically, the mobile station may be configured to maintain the identical value without incrementing the ACC if the data quantity within the buffer is zero, and is configured to increment the ACC by one in a case other than it.

Further, the mobile station is configured to reset the ACC to zero if the data quantity within the buffer is zero, and is configured to increment the ACC by one in a case other than it.

Additionally, herein, the explanation was made on the premise that the mobile station, being one component of the hardware configuration shown in FIG. 12 executed the operational flow shown in FIG. 13, and it is also possible that a program stored in the memory within the mobile station, which is not shown in the figure, causes hardware having a function identical to that of the hardware configuration shown in FIG. 12 to execute the operational flow shown in FIG. 13.

Additionally, in the first to fifth exemplary embodiments mentioned above, a configuration may be made so that the maximum value of the ACC is limited. For example, a configuration may be made so that the maximum value of the ACC is set as three, and the ACC, of the value has reached the maximum value, is not incremented more than it, or is reset to zero.

Additionally, in the first to fifth exemplary embodiments mentioned above, a configuration may be made so that the ACC is reset to zero in a case where the mobile station has received the AG.

Additionally, in each of the above-mentioned exemplary embodiments, the scheduling was shown for controlling the power offset of the mobile station by exemplifying the EUDCH, and an object of the control in this claimed invention is not always limited to the power offset of the mobile station of the EUDCH. The matter associated with the scheduling of the radio resource quantity in the radio communication could be an object of the control, for example, a width of a frequency band, an allocation time quantity in a time division, or the like could be an object of the control.

Further, the radio resource quantity that may be used (permitted radio resource quantity) is not limited to the radio resource quantity associated with uplink channel from the mobile station to the base station. The permitted radio resource quantity associated with downlink channel from the base station to the radio station is also acceptable. Each of roles of the mobile station and the base station can be shifted to the other at the moment that both control the radio resource quantity of the channel being used for transmitting a signal as a communication station.

1-31. (canceled)

32. A signal transmission method in a radio communication system being configured at least of a first communication station and a second communication station, characterized in that:
said first communication station comprises a step of transmitting a signal for notifying a request for changing a radio resource quantity that said second communication station may use; and
said second communication station comprises a step of receiving said signal and a step of updating the radio resource quantity that said second communication station may use responding to said signal, accumulation information of said signal, and the radio resource quantity used ahead of a predetermined time.

33. The signal transmission method according to claim 32, characterized in that said second communication station further comprises a step of transmitting a signal with a radio resource quantity equal to or less than said updated radio resource quantity.

34. The signal transmission method according to claim 32, characterized in that said second communication station further comprises a step of increasing said accumulation information when a transmission format of the signal from said second communication station to said first communication station selected by said second communication station based upon a result of receiving a signal for giving an instruction for increasing said radio resource quantity is identical to a transmission format of the signal used ahead of a predetermined time.

35. The signal transmission method according to claim 32, characterized in that said second communication station further comprises a step of increasing said accumulation information when the radio resource quantity updated based upon reception of a signal for giving an instruction for increasing said radio resource quantity is identical to the radio resource quantity that existed ahead of a predetermined time.

36. The signal transmission method according to claim 32, characterized in that said second communication station further comprises the steps of:
transmitting a signal with a radio resource quantity; equal to or less than said updated radio resource quantity
measuring a power with which a signal has been transmitted; and
selecting a transmission format of the signal based upon said measured power and said updated radio resource quantity.

37. The signal transmission method according to claim 34, characterized in that said second communication station resets said accumulation information to a predetermined initial value in a case of having selected a transmission format different from the transmission format used ahead of said predetermined time.

38. The signal transmission method according to claim 32, characterized in that said second communication station resets said accumulation information to a predetermined initial value when the radio resource quantity that said second communication station may use differs from the radio resource quantity used ahead of said predetermined time.

39. The signal transmission method according to claim 32, characterized in that said second communication station further comprises a step of, when the signal received from said first communication station is a signal from a first communication station performing scheduling for the radio resource quantity of said second communication station, which is for notifying a request for changing the radio resource quantity that the above second communication station may use, updating said accumulation information based upon its result.

40. The signal transmission method according to claim 34, characterized in that, only when the transmission format used ahead of said predetermined time belongs to a subset of a predetermined transmission format, said second communication station increases said accumulation information based upon reception of a signal for giving an instruction for increasing said radio resource quantity.

41. A radio communication system being configured at least of a first communication station and a second communication station, characterized in that:
said first communication station comprising a means for transmitting a signal for notifying a request for changing a radio resource quantity that said second communication station may use;
said second communication station comprises a means for receiving said signal, and an updating means for updating the radio resource quantity that said second communication station may use responding to said signal, accumulation information of said signal, and the radio resource quantity used ahead of a predetermined time.

42. The radio communication system according to claim 41, characterized in that said second communication station further comprises a means for transmitting a signal with a radio resource quantity equal to or less than said updated radio resource quantity.

43. The radio communication system according to claim 41, characterized in that said second communication station further comprises an accumulation information measuring means for increasing said accumulation information when a transmission format of the signal from said first communication station to said second communication station selected by said second communication station based upon a result of receiving a signal for giving an instruction for increasing said radio resource quantity is identical to a transmission format of the signal used ahead of a predetermined time.

44. The radio communication system according to claim 41, characterized in that said second communication station further comprises an accumulation information measuring means for increasing said accumulation information when the radio resource quantity updated based upon reception of the signal for giving an instruction for increasing said radio resource quantity is identical to the radio resource quantity that existed ahead of a predetermined time.

45. The radio communication system according to claim 41, characterized in that said second communication station further comprises:
a transmitting means for transmitting a signal with a radio resource quantity equal to or less than said updated radio resource quantity;
a transmission power measuring unit for measuring a power with which said transmitting means has transmitted the signal; and
a selecting means for selecting a transmission format of the signal from said transmitting means based upon a measurement result by said transmission power measuring unit and the radio resource quantity updated by said updating means that said second communication station may use.

46. The radio communication system according to claim 45, characterized in that said accumulation information measuring means of said second communication station resets said accumulation information to a predetermined initial value in a case where said selecting means has selected a transmission format different from the transmission format used ahead of said predetermined time.

47. The radio communication system according to claim 41, characterized in that said second communication station comprises a means for resetting said accumulation information to a predetermined initial value when the radio resource quantity that said second communication station may use differs from the radio resource quantity used ahead of said predetermined time.

48. The radio communication system according to claim 41, characterized in that:
said first communication station comprises a means for transmitting a signal for notifying a request for changing the radio resource quantity that said second communication station may use;
said second communication station comprises:
a means for receiving said signal;
a measuring means for, when said signal is a signal from the first communication station performing scheduling for the radio resource quantity of said second communication station, which is for notifying a request for changing the radio resource quantity that the above second communication station may use, measuring said accumulation information based upon its result; and
an updating means for updating the radio resource quantity that said second communication station may use responding to said signal, accumulation information of said signal, and the radio resource quantity used ahead of a predetermined time.

49. The radio communication system according to claim 43, characterized in that, only when the transmission format used ahead of said predetermined time belongs to a subset of a predetermined transmission format, said second communication station increases said accumulation information based upon reception of the signal for giving an instruction for increasing said radio resource quantity.

50. A communication station in a radio communication system, comprising:
a means for receiving from other communication station a signal for notifying a request for changing a radio resource quantity that its own station may use; and
an updating means for updating the radio resource quantity that its own station may use responding to said signal, accumulation information of said signal, and the radio resource quantity used ahead of a predetermined time.

51. The communication station according to claim 50, characterized in further comprising a transmitting means for transmitting a signal with a radio resource quantity equal to or less than said updated radio resource quantity.

52. The communication station according to claim 50, characterized in further comprising an accumulation information measuring means for measuring as said accumulation information the number of times in the case that a transmission format of the signal from its own station to other communication station selected based upon a result of receiving a signal for giving an instruction for increasing the radio resource quantity of said its own station is identical to a transmission format of the signal used ahead of a predetermined time.

53. The communication station according to claim 50, characterized in further comprising an accumulation information measuring means for increasing said accumulation information when the radio resource quantity updated based upon reception of the signal for giving an instruction for increasing said radio resource quantity is identical to the radio resource quantity that existed ahead of a predetermined time.

54. The communication station according to claim 50, characterized in further comprising:
a transmitting means for transmitting a signal with a radio resource quantity equal to or less than said updated radio resource quantity;
a transmission power measuring unit for measuring a power with which said transmitting means has transmitted the signal; and
a selecting means for selecting a transmission format of the signal from said transmitting means based upon a measurement result by said transmission power measuring unit and the radio resource quantity updated by said updating means that said second communication station may use.

55. The communication station according to claim 54, characterized in that said accumulation information measuring means resets said accumulation information to a predetermined initial value in a case where said selecting means has selected a transmission format different from the transmission format used ahead of said predetermined time.

56. The communication station according to claim 52, characterized in that said accumulation information measuring means resets said accumulation information to a predetermined initial value when the radio resource quantity that said communication station may use differs from the radio resource quantity used ahead of said predetermined time.

57. The communication station according to claim 50, characterized in comprising:
a means for receiving from the other communication station a signal for notifying a request for changing the radio resource quantity that its own station may use;
a measuring means for, when said signal is a signal from the other communication station performing scheduling for the radio resource quantity of its own station, which is for notifying a request for changing the radio resource quantity that its own station may use, measuring said accumulation information based upon its result; and
an updating means for updating the radio resource quantity that its own station may use responding to said signal, accumulation information of said signal, and the radio resource quantity used ahead of a predetermined time.

58. The communication station according to claim 50, characterized in that, only when the transmission format used ahead of said predetermined time belongs to a subset of a predetermined transmission format, said second communication station increases said accumulation information based upon reception of a signal for giving an instruction for increasing said radio resource quantity.

59. A signal transmission method in a communication station of a radio communication system, comprising the steps of:
receiving from other communication station a signal for notifying a request for changing a radio resource quantity that its own station may use; and
updating the radio resource quantity that said second communication station may use responding to said signal, accumulation information of said signal, and the radio resource quantity used ahead of a predetermined time.

60. A radio communication system being configured at least of a first communication station and a second communication station, characterized in that:
said first communication station comprises a means for transmitting a signal for notifying a request for changing a radio resource quantity that said second communication station may use;
said second communication station comprises:
a means for receiving said signal; and
an updating means for:
in a case where said signal is a signal indicating an increase in the radio resource quantity, increasing the radio resource quantity of accumulation information when the value obtained by subtracting the radio resource quantity of the accumulation information from the radio resource quantity that said second communication station may use is identical to a value obtained by adding a predetermined radio resource quantity to the radio resource quantity used ahead of a predetermined time;
when the value obtained by subtracting the radio resource quantity of the accumulation information from the radio resource quantity that said second communication station may use differs from a value obtained by adding a predetermined radio resource quantity to the radio resource quantity used ahead of a predetermined time, resetting the radio resource quantity of said accumulation information to a predetermined initial value; and
assuming the value obtained by adding a predetermined radio resource quantity and the radio resource quantity of the accumulation information to the radio resource quantity used ahead of a predetermined time to be a radio resource quantity that said second communication station may use;
said updating means, when said signal is a signal indicating a decrease in the radio resource quantity, further assumes the value obtained by subtracting a predetermined radio resource quantity from the radio resource quantity used ahead of a predetermined time to be a radio resource quantity that said second communication station may use; and
said second communication station comprises a means for making transmission by using the radio resource quantity that does not exceed said radio resource quantity that may be used.

61. A communication station in a radio communication system, characterized in that:
said communication station comprises:
a means for receiving said signal; and
an updating means for:
in a case where said signal is a signal indicating an increase in the radio resource quantity, increasing the radio resource quantity of accumulation information when the value obtained by subtracting the radio resource quantity of the accumulation information from the radio resource quantity that its own station may use is identical to a value obtained by adding a predetermined radio resource quantity to the radio resource quantity used ahead of a predetermined time;
when the value obtained by subtracting the radio resource quantity of accumulation information from the radio resource quantity that its own station may use differs from a value obtained by adding a predetermined radio resource quantity to the radio resource quantity used ahead of a predetermined time, resetting the radio resource quantity of said accumulation information to a predetermined initial value; and
assuming the value obtained by adding a predetermined radio resource quantity and the radio resource quantity of the accumulation information to the radio resource quantity used ahead of a predetermined time to be a radio resource quantity that its own station may use;
said updating means, when said signal is a signal indicating a decrease in the radio resource quantity, further assumes the value obtained by subtracting a predetermined radio resource quantity from the radio resource quantity used ahead of a predetermined time to be a radio resource quantity that said its own station may use; and
said its own station comprises a means for making transmission by using the radio resource quantity that does not exceed the radio resource quantity that may be used.

62. A signal transmission method in a communication station of a radio communication system, characterized in comprising of:
a step of receiving from a first communication station a signal for notifying a request for changing a radio resource quantity that its own station may use;
a step of:
in a case where said signal is a signal indicating an increase in the radio resource quantity, increasing the radio resource quantity of accumulation information when the value obtained by subtracting the radio resource quantity of the accumulation information from the radio resource quantity that its own station may use is identical to a value obtained by adding a predetermined radio resource quantity to the radio resource quantity used ahead of a predetermined time, and resetting the radio resource quantity of said accumulation information to a predetermined initial value when the value obtained by subtracting the radio resource quantity of the accumulation information from the radio resource quantity that its own station may use differs from a value obtained by adding a predetermined radio resource quantity to the radio resource quantity used ahead of a predetermined time; and
assuming the value obtained by adding a predetermined radio resource quantity and the radio resource quantity of the accumulation information to the radio resource quantity used ahead of a predetermined time to be a radio resource quantity that its own station may use;
a step of, when said signal is a signal indicating a decrease in the radio resource quantity, assuming the value obtained by subtracting a predetermined radio resource quantity from the radio resource quantity used ahead of a predetermined time to be a radio resource quantity that its own station may use; and
a step of making transmission by using the radio resource quantity that does not exceed the radio resource quantity that its own station may use.
